(19) United States
(12) Patent Application Publication
(10) Pub. No.: US 2014/0358806 A1
(43) Pub. Date: Dec. 4, 2014

(54) SYSTEMS AND METHODS FOR REGISTRATION AND SHARING OF TOYS AND APPAREL TO CREATE LINKS IN AN ONLINE SOCIAL NETWORK

(71) Applicant: Flairgameworld LLC, Westport, CT (US)

(72) Inventors: Allison Quinn DiVincenzo, Westport, CT (US); Geoffry Meek, Providence, RI (US)

(73) Assignee: Flairgameworld LLC, Westport, CT (US)

(21) Appl. No.: 14/291,499

(22) Filed: May 30, 2014

Related U.S. Application Data
(60) Provisional application No. 61/829,949, filed on May 31, 2013.

(51) Int. Cl. G06Q 30/00; G06Q 50/00

(52) U.S. Cl. CPC G06Q 30/00; G06Q 50/01
USPC 705/319

(57) ABSTRACT

Systems and methods of the present disclosure facilitate relating users in an online social network. In one embodiment, the system can receive a first registration code of a first physical toy via a first scanning device and modify a first user account to include the first registration code. The system can also receive a second registration code of a second physical toy via a second scanning device and modify a second user account to include the second registration code. Responsive to the system then receiving the second registration code via the first scanning device, and receiving the first registration code via the second scanning device, the system can compare the first user account with the second user account. Based on the comparison, the system can identify a transaction between the first and second user accounts to generate a link in the social network between the first and second user accounts.

### CROSS-REFERENCE TO RELATED PATENT APPLICATIONS

This application claims the benefit of priority under 35 U.S.C. §119 to U.S. Provisional Patent Application No. 61/829,949, titled “SYSTEMS AND METHODS FOR TOYS AND APPAREL THAT CAN BE USED IN THE REAL WORLD AS WELL AS IN AN ONLINE SOCIAL NETWORK,” and filed on May 31, 2013, the entirety of which is hereby incorporated by reference.

### FIELD OF THE DISCLOSURE

The present disclosure generally relates to online registration and social networks. More specifically, the present disclosure relates to online registration of toys that are fastened to apparel, and sharing the toys in order to create links in an online social network.

### BACKGROUND OF THE INVENTION

Online social networks include user accounts that are linked to one another.

### SUMMARY OF THE INVENTION

Systems, methods and apparatus of the present disclosure provide for registering physical toys in user accounts of a social network, determining a transaction between user accounts based on the sharing or exchanging of the physical toys, and generating a link between the user accounts based on the transaction.

In some embodiments, the physical toys can incorporate fasteners that can allow the toys to be fastened to articles of apparel. By fastening the toys to articles of apparel that they wear, customers or users (such as children of all ages or adults) can carry the toys with them all day, and also display the toys to their friends. In addition, the customer may be able to fasten the toys to the apparel in such a way as to create interesting and attractive designs that can stimulate the creativity of the customer. The designs can make the apparel unique and can convey a visual appearance that can be very personalized.

Customers can interact with one another in online games and social networks via a user interface of an online system. Systems, methods and apparatus of the present disclosure facilitate personalizing the online experience for the customer. For example, physical toys can be manufactured with a registration code that can be sent to a server, and the server can be configured to keep track of the toys. The server may also be configured to manage user accounts associated with the customers, and the user accounts can facilitate tracking the owners of the toys. The server can be configured to create virtual counterparts of the toys that can be used in online games and social networks. The virtual counterparts can be manipulated by the customers in a virtual world online in many of the same ways that the actual physical toys can be manipulated in the real world. In addition, the server may be configured to manipulate the virtual counterparts of the toys in ways that could be difficult or impossible to manipulate the actual physical toys.

Customers may be interested in trading toys between each other. The customers may trade their toys with other customers, but the market can be inefficient because it may be limited to customers that are see often, and may also be limited to the toys that the customers carry with them on a regular basis.

The present disclosure can facilitate making the market for trading the toys more efficient in several ways. Fastening the toys to apparel can encourage the customer to carry and display more of the toys on a regular basis, which can make other customers aware of the toys and can therefore facilitate trading. Registering the toys online can facilitate the customers or users in searching and advertising toys that they want to trade, which can facilitate increasing the size of the market and can therefore facilitate trading. Creating virtual counterparts of the toys can enable virtual trading, where the virtual toys are traded online without actually trading the physical toys, which can facilitate trading by allowing trades between customers who may not be able to meet in person.

The articles of apparel to which the toys can be fastened may also be manufactured in such a way as to facilitate their use with the toys. The apparel may incorporate designs that can suggest the choice and location of certain toys to be fastened. The articles of apparel may have registration codes in the same way that the toys can have registration codes, so that the apparel may also be registered on the server. The server may be configured to create virtual counterparts of the apparel that is registered, and these virtual counterparts of the apparel may be used in activities in the virtual world on the server. For example, the users of the virtual world may be able to fasten the virtual counterparts of toys to the virtual counterparts of apparel. In another example, the users of the virtual world may be able to virtually trade virtual apparel in addition to virtually trading virtual toys.

The social network may be enhanced by the registration and sharing of the toys and apparel. The sharing activity can create links in the social network, and the links can be weighted by the characteristics of the toys, the location of the toys, the utilization of the toys, the characteristics of the articles of apparel, the location of the articles of apparel, and so on. The social network may also make recommendations about trading activity or new links based on the characteristics of the toys, the location of the toys, the utilization of the toys, the characteristics of the articles of apparel, the location of the articles of apparel, the match between the toys and the articles of apparel, and so on. The social network may also serve as a good forum for implementing a marketplace for toys and apparel.

Systems, methods and apparatus of the present disclosure allow customers to be creative by facilitating the creation of new and unique designs of toys and apparel. The server may be configured to provide online design tools that can facilitate modifying the designs of existing toys and apparel. The modifications to the design may be relatively simple, such as changing colors or patterns, or they may be more involved, such as changing the shape or configuration of the design, or applying new images to the design. The design tools may even support relatively complex computer-aided design (CAD) functions that can allow creating a completely new design. The server may be configured to send the new designs to a manufacturing process that can create a physical toy or article of apparel, which may then be delivered to the child who created the design. The virtual world may be configured to provide a virtual marketplace that may allow the customer who created the design to offer the new design, either as a virtual item or as an actual physical item, to other users/customers of the virtual world.

At least one aspect of the present disclosure is directed to a system for relating a first user with a second user in an online social network. The system can include a server. The server may be configured to access a first data structure storing, in a memory element, a first user account associated with the first user in the social network. The server may be configured to access a second data structure storing, in a memory element, a second user account associated with the second user in the social network. The server may be configured to associate a first identifier of a first scanning device with the first user account, via the first data structure. The server may be configured to associate a second identifier of a second scanning device with the second user account, via the second data structure. The server may be configured to modify, responsive to receiving a first registration code of a first physical toy via the first scanning device, the first user account to include the first registration code of the first physical toy. The server may be configured to modify, responsive to receiving a second registration code of a second physical toy via the second scanning device, the second user account to include the second registration code of the second physical toy. The server may be configured to receive, via the first scanning device, the second registration code of the second physical toy. The server may be configured to receive, via the second scanning device, the first registration code of the first physical toy. The server may be configured to compare, responsive to receiving the second registration code via the first scanning device and the first registration code via the second scanning device, the first user account with the second user account. The server may be configured to identify, based on the comparison, a transaction between the first user account and the second user account, the transaction including the first physical toy and the second physical toy. The server may be configured to generate a link in the social network between the first user account and the second user account based on the identification of the transaction between the first user account and the second user account.

In some embodiments, the server may identify a first characteristic of the first physical toy, such as a type of physical toy (e.g., doll, action figure, handheld video game, board game, clothing accessory, or jewelry), category of the physical toy (e.g., aquatic toy, inside toy, outside toy, toys that use batteries or may need assembly, safe toys, or toys that require parental supervision), suggested age range for the physical toy, model year of the physical toy, quantity of the physical toy, geographic region of origin of the physical toy (e.g., country where toy was designed, country where the physical toy was manufactured, or country where the physical toy was sold). The server may identify the first characteristic based on the first registration code. The server may identify a second characteristic of the second physical toy based on the second registration code. The server may compare the first characteristic of the first physical toy with the second characteristic of the second physical toy. The server may weight the link in the social network between the first user account and the second user account. The server may weight the link based on the comparison of the first characteristic and the second characteristic. Links associated with toys that share a characteristic may be weighted more heavily than links created based on toys that do not share a similar characteristic. For example, a link may be weighted higher if both toys are dolls, as compared to where a first toy is a doll and a second toy is piece of jewelry. A link may be weighted more heavily if the toys are related. For example, customers interested in dolls may also be interested in jewelry, whereas customers interested in jewelry may not be interested in action figures. Thus, a link created based on trading or sharing dolls and jewelry may be weighted higher than a link created based on trading a piece of jewelry with an action figure. In another example, the server may determine to weight a link created between trading a piece of jewelry and an action figure higher because it is a less common trade, and may indicate a stronger friendship between the customers. In some embodiments, the weights may be generated based on historical trading/sharing/exchanging activity, geographic locations of past or current trades, number of friends in common, etc.

In some embodiments, the server may associate a first virtual toy with the first registration code of the first physical toy. The server may associate the first virtual toy with the first registration code via the first data structure. The server may associate a second virtual toy with the second registration code of the second physical toy. The server may associate the second virtual toy with the second registration code via the second data structure.

In some embodiments, the server can include a production module. Responsive to input from the first user, the server may modify the first virtual toy via the first data structure. The server may initiate manufacturing of a third physical toy based on the modification.

In some embodiments, the server may associate, via the first data structure, a first location identifier of a first location device with the first user account. The server may associate, via the second data structure, a second location identifier of a second location device with the second user account. The server may receive, via the first location device, a first location of the first physical toy. The server may receive, via the second location device, a second location of the second physical toy. The server may modify, responsive to receiving the first location, the first data structure to include the first location of the first physical toy. The server may modify, responsive to receiving the second location, the second data structure to include the second location of the second physical toy.

In some embodiments, the server may compare the first location of the first physical toy and the second location of the second physical toy. The server may weight, based on the comparison of the first location and the second location, the link in the social network between the first user account and the second user account.

In some embodiments, the server may associate, via the data structure, a box identifier of a storage box with the first user account. The server may receive, via the storage box, a utilization statistic of the first physical toy. The server may modify, responsive to receiving the utilization statistic, the first data structure to include the utilization statistic of the first physical toy. In some embodiments, the server may weight, based on the utilization statistic, the link in the social network between the first user account and the second user account.

In some embodiments, the server may modify, responsive to receiving a first apparel registration code of a first article of apparel via the first scanning device, the first user account to include the first apparel registration code of the first article of apparel. In some embodiments, the server may modify the second user account to include the second apparel registration code of the second article of apparel. The server may modify the second user account responsive to receiving a second apparel registration code of a second article of apparel via the second scanning device. In some embodiments, the server may compare the first apparel registration code of the first article of apparel and the second apparel registration code of the second article of apparel. In some embodiments, the server may weight, based on the comparison, the link in the social network between the first user account and the second user account. In some embodiments, the server may compare the first apparel registration code of the first article of apparel and the first registration code of the first physical toy. In some embodiments, the server may generate, based on the comparison, a recommendation for a purchase of a third physical toy. In some embodiments, the server may display the recommendation responsive to input from the first user.

In some embodiments, the server may associate, via the first data structure, a first virtual article of apparel with the first apparel registration code of the first article of apparel. In some embodiments, the server may include a production module. The server may modify, responsive to input from the first user, via the first data structure, the first virtual article of apparel. The server may initiate manufacturing of a third article of apparel based on the modification. The server may initiate manufacturing by providing a blue print, CAD drawings, or other design pattern or specification for the toy. The server may initiate manufacturing by providing the design specification or requirements of the new toy to user, manufacturer, storage device, manufacturing facility, three-dimensional (“3D”) printer or additive manufacturing device. For example, the server may provide a digital model of the design specification in a format compatible with a 3D printer (e.g., Stereolithography file format, CAD format, Standard Tessellation Language, ASCII or binary representations) which may then create the physical toy for the customer.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1A is an illustrative block diagram of an embodiment of a system for registration and sharing of toys and apparel to create links in an online social network.

FIG. 1B is an illustrative block diagram of an embodiment of a system for registration and sharing of toys and apparel to create links in an online social network, and the creation of virtual counterparts of the toys and apparel.

FIG. 1C is an illustrative block diagram of an embodiment of a system for registration and sharing of toys and apparel to create links in an online social network, and the design and manufacture of toys and apparel.

FIG. 2 is an illustrative block diagram of an embodiment of a system for facilitating the use and distribution of toys and apparel that can shared to create links in an online social network.

FIG. 3A is an illustrative image of an embodiment of toys that can be shared in the real world.

FIG. 3B is an illustrative image of an embodiment of a toy with a magnetic fastener that can attach it to an item of apparel.

FIG. 3C is an illustrative diagram of an embodiment of a snap fastener that can attach a toy to an item of apparel.

FIG. 3D is an illustrative image of an embodiment of a toy being attached to an item of apparel.

FIG. 3E is an illustrative image of an embodiment of a magnet pair that can be used to attach a toy to an item of apparel.

FIG. 3F is an illustrative diagram of an embodiment of a fabric enclosure that can be used around a magnet.

FIG. 4A is an illustrative image of an embodiment of items of apparel that can have a toy attached to them.

FIG. 4B is an illustrative image of an embodiment of printing for an item of apparel that can be suggestive of positions for attaching toys.

FIG. 5A is an illustrative diagram of an embodiment of a tag that can be used on a toy, with an identifier that can be used to register the toy online.

FIG. 5B is an illustrative diagram of an embodiment of a tag that can be used on a toy, with a Quick Response (QR) code that can be used to register the toy online.

FIG. 5C is an illustrative block diagram of an embodiment of a toy with a Radio Frequency IDentification (RFID) tag that can be used to register the toy online

FIG. 5D is an illustrative example of an embodiment of a user interface that can be used to register a toy online.

FIG. 5E is an illustrative example of an embodiment of a user interface that can be used to access a user account to register a toy online.

FIG. 6A is an illustrative block diagram of an embodiment of trading toys between individuals and tracking the trading.

FIG. 6B is an illustrative image of an embodiment of a storage box that can be used for toys.

FIG. 6C is an illustrative example of an embodiment of a user interface that can be used to track the trading activity of a toy.

FIG. 7A is an illustrative block diagram of an embodiment of a virtual world.

FIG. 7B is an illustrative example of an embodiment of a user interface that can be used to customize a character in a virtual world.

FIG. 7C is an illustrative example of an embodiment of a user interface that can be used to attach virtual toys to virtual apparel on a character in a virtual world.

FIG. 8A is an illustrative block diagram of an embodiment of an online social network.

FIG. 8B is an illustrative example of an embodiment of a user interface that can be used to interact between members of an online social network.

FIG. 9 is an illustrative block diagram of an embodiment of a system that can support an online user designing a virtual product that can then be created as a real world product.

FIG. 10A is an illustrative flowchart depicting an example embodiment of a method of registering and sharing toys and apparel and creating links in an online social network.

FIG. 10B is an illustrative flowchart depicting an example embodiment of a method of registering and sharing toys and apparel and creating links in an online social network, and creating virtual counterparts of the toys and apparel.

FIG. 10C is an illustrative flowchart depicting an example embodiment of a method of registering and sharing toys and apparel and creating links in an online social network, and designing and manufacturing toys.

Like reference numbers and designations in the various drawings indicate like elements.

### DETAILED DESCRIPTION

Systems and methods of the present disclosure can facilitate relating users in an online social network. The system can contain toys that can be manufactured with a fastener that allows them to be fastened to articles of apparel. The toys may then serve as fashion accessories, and can facilitate in decorating the apparel in ways that their owner finds attractive and unique. The articles of apparel can also be manufactured in such a way as to facilitate their use with the toys. The apparel may incorporate designs that can suggest the choice and location of certain toys to be fastened.

The toys can be manufactured with a unique identifier, such as a serial number, that may be used as a registration code in an online registration process to register the toys on a server. The registration code may be sent to the server using a manual process, or the registration code may be encoded in such a way that a scanning device may be able to send the registration code to the server with little or no manual intervention. The registration code may also not be unique for every toy, but may identify the toy as a member of a class, such as a model number. The articles of apparel may also have similar registration codes, and the articles of apparel may also be registered on the server in a similar fashion.

The owners of the toys may trade the toys between each other. The server can be configured to allow the owners of the toys to register the trades, which may be done using the registration codes on the toys being traded. The server may also be configured to allow the owners of toys to “share” the toys, which may be like a trade except that the owners maintain possession of the physical toys.

The server can be configured to create and maintain a virtual counterpart of the toys and apparel that are registered on the server. These virtual counterparts may then be part of a virtual world that the users of the system can interact with. The server can be configured to create and maintain user accounts that can be associated with the owners of the toys. The server may be able to use the user accounts and registration codes to keep track of the toys and apparel and their virtual counterparts. The server may use this information to mirror activity from the real world into the virtual world, such as movement of the real toys or trades of the real toys between the owners of the toys. The server may be configured to treat sharing of toys as a virtual trade of the virtual counterpart of the toys. The server may also be configured to treat sharing of toys by duplicating the virtual counterparts of the shared toys for ownership by both user accounts participating in the sharing.

The server can be configured to provide a social network for the owners of the toys. The social network may set up links between users by using trades of the toys between their owners. The links may be set up on the basis of real trades of real toys, sharing of toys, virtual trades of virtual toys, real trades of real articles of apparel, sharing of articles of apparel, virtual trades of virtual articles of apparel, and so on. The links may also be set up on the basis of recommendations by existing friends, other mechanisms that are used by other existing social networks, and so on.

In an illustrative example, Alice may buy a duck toy at a retail store, create a user account on the server, log in, and type in the registration code from the duck toy to register it. Bob may create a user account on the server, log in, and buy a dog toy and a shirt online. The server may automatically register Bob's dog toy and his shirt since he is buying them online. Alice may fasten her duck toy to her headband, and Bob may fasten his dog toy to his shirt.

Alice and Bob may attend the same school. Alice may see Bob's dog toy on his shirt, and Bob may see Alice's duck toy on her headband. Alice may like Bob's dog toy, since it may look like her dog. Bob may like Alice's duck toy, since his shirt may have a water scene printed on it that would look better with a duck than with a dog. Alice and Bob may decide to trade toys. They may then use their cell phones to scan the registration codes from their new toys and register the new toys and the trade on the server.

The next time Bob logs in to the server, he may see that he has Alice as a new friend in the social network on the server. He may also see that he has a virtual duck toy that he can virtually fasten to his virtual shirt. He may also have an invitation from Alice to become a friend of Charlie in the social network, because Charlie is already a friend of Alice. Bob may accept the invitation, and then find that Charlie is interested in trading a fish toy for a duck toy. The social network may weight the link between Bob and Charlie more heavily than the link between Alice and Bob, based on the fact that Bob and Charlie both have toys that represent aquatic animals. The social network may also weight the link between Bob and Charlie more heavily that the link between Alice and Bob, based on the fact that Bob has an article of apparel with a water scene on it and Charlie has an aquatic toy. Bob may discover that Charlie goes to the same school as Alice and Bob. Bob may prefer the way Charlie's fish toy would look on his shirt, as opposed to his own duck toy. The next day, Bob may introduce himself to Charlie and trade his duck toy for Charlie's fish toy.

Bob may decide that even though the fish toy looks good on his shirt, he would really like it better if the fish were red instead of blue. Bob may use a design tool on the server to modify the design of the fish toy and change it to be the red color that he likes. Bob may then buy the toy with his new design online and have it delivered. Another user, Eve, who lives across the country from Bob, may see Bob's design in the store and decide that she would like to have it. Eve may buy the toy with Bob's design. Bob may now see Eve as a suggested friend on the social network. Bob may accept the friend recommendation, and Eve may send Bob a message indicating that she really likes Bob's design. The server may be able to use location services to determine the physical locations of Alice, Bob, Charlie, and Eve, and the social network may weight the link between Bob and Eve less heavily than the link between Bob and Charlie, based on the fact that Bob and Eve are physically located farther apart from each other.

Eve may have a storage box for her toys that can read the RFID tags on her toys. The storage box may discover that Eve has a shark toy that Eve has left in the storage box for the last two months, even though she may have used her other toys from the box during that time. The storage box may transmit this information to the server, and the social network may make a recommendation to Bob and Eve that Eve may be interesting in trading her shark toy, based on the fact that Bob may have an interest in aquatic toys and Eve may not be interested in her shark toy.

Alice may also have a storage box for her toys that can read the RFID tags on her toys. The storage boxes for both Alice and Eve may discover that both Alice and Eve have a collection of flower toys that are removed from their storage boxes very frequently. The social network may suggest a link between Alice and Eve, and may weight the link more heavily than the link between Bob and Eve, based on the fact that Alice and Eve appear to have a common interest in flower toys.

Eve may have a shirt with a water scene on it like Bob's shirt, but she may really be more interested in the beach. Eve may use a design tool on the server to modify the design of her shirt and change the background to be a beach scene. Eve may then buy the shirt with her new design online and have it delivered. Bob may see Eve's new shirt on the social network and may decide that he would like to have it. Bob may buy the shirt with Eve's design.

In another illustrative example, Alice may like Bob's dog toy, and Bob may like Alice's duck toy, but Alice and Bob may both prefer to keep their respective toys for themselves. They can still use their cell phones to scan the registration codes from each other's toys and register the new toys, and the fact that they have “shared” with each other, on the server. The sharing can be indicated by the fact that Alice allows Bob to scan the registration code from her duck toy, and the fact that Bob allows Alice to scan the registration code from her dog toy.

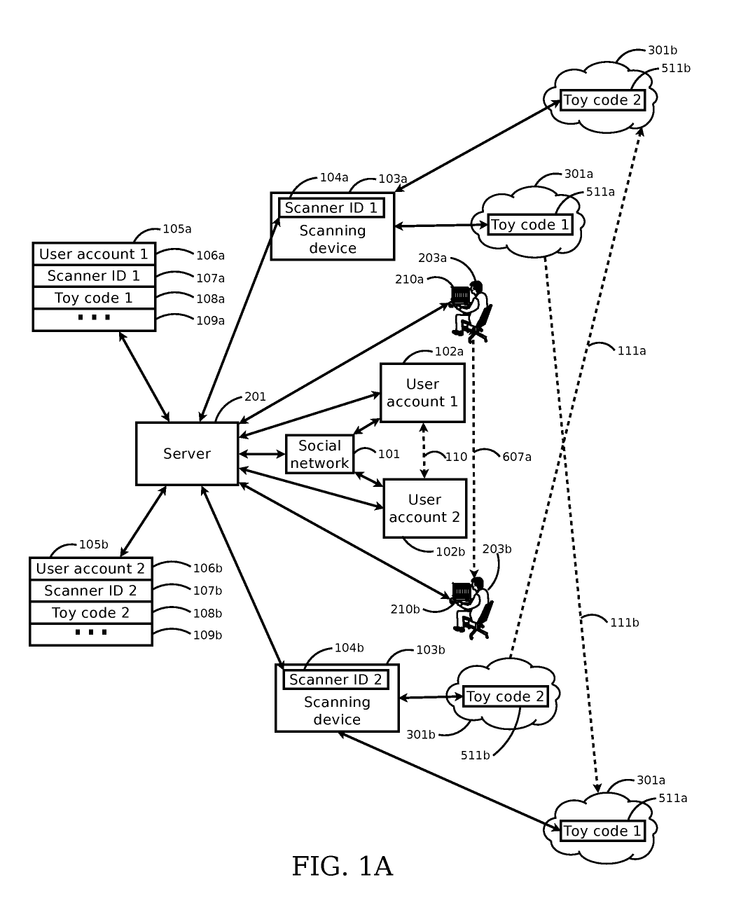

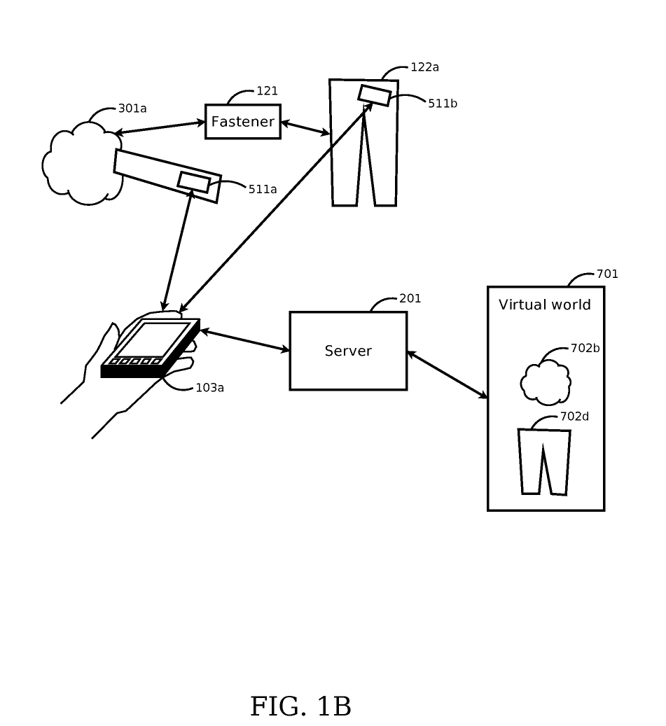

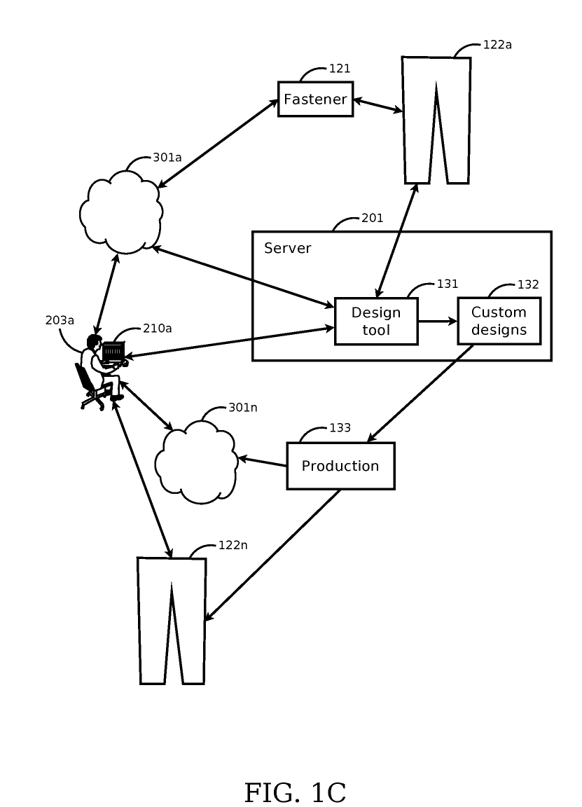

Turning to the drawings, FIG. 1A is an illustrative block diagram of an embodiment of a system for registration and sharing of toys and apparel to create links in an online social network. A user 203a may use a device 210a to access a server 201, and may create a user account 102a. A user 203b may use a device 210b to access a server 201, and may create a user account 102b. The server 201 may implement a social network 101, and the social network 101 may use the user accounts 102a-102b. A scanning device 103a may contain a scanner identification 104a which may be transmitted to the server 201. The scanning device 103a may be able to read a toy code 511a from a toy 301a, and may be able to transmit the toy code 511a to the server 201. A scanning device 103b may contain a scanner identification 104b which may be transmitted to the server 201. The scanning device 103b may be able to read a toy code 511b from a toy 301b, and may be able to transmit the toy code 511b to the server 201. The server 201 may access a data structure 105a, which may in turn include information such as a reference 106a to the user account 102a, a reference 107a to the scanning device 103a using the scanner identification 104a, a reference 108a to the toy 301a using the toy code 511a, and additional information 109a. The server 201 may access a data structure 105b, which may in turn include information such as a reference 106b to the user account 102b, a reference 107b to the scanning device 103b using the scanner identification 104b, a reference 108b to the toy 301b using the toy code 511b, and additional information 109b.

The user 203a may choose 111b to make the toy 301a accessible to the user 203b. The user 203b can use the scanning device 103b to scan the toy code 511a from the toy 301a and transmit it to the server 201. The user 203b may choose 111a to make the toy 301b accessible to the user 203a. The user 203a can use the scanning device 103a to scan the toy code 511b from the toy 301b and transmit it to the server 201. The server 201 may be able to use the information from the data structures 105a and 105b to compare the user accounts 102a and 102b and identify a transaction 110 between the user accounts 102a and 102b. This may facilitate the server 201 in generating a link 607a in the social network 101 between the users 203a and 203b. The toy codes 511a-511b may provide information about characteristics of the toys 301a-301b such as styles, themes, colors, sizes, materials, and so on. The social network 101 may use these characteristics to weight the link 607a more or less heavily. For example, the social network 101 may weight the link 607a more heavily if the toys 301a and 301b have the same theme, since the two users 203a and 203b may share a common interest in that theme.

The scanning modules 103a-103b may include, for example, a cell phone, a bar code scanner, an RFID reader, a camera with recognition software, a magnetic reader, a QR code scanner, and so on. The scanning modules 103a-103b may be directed to manual reading and entry of a code.

FIG. 1B is an illustrative block diagram of an embodiment of a system for registration and sharing of toys and apparel to create links in an online social network, and the creation of virtual counterparts of the toys and apparel. A fastener 121 can be used to fasten a toy 301a to an article of apparel 122a. A scanning module 103a can read a registration code 511a from the toy 301a and send the registration code 511a to a server 201. The server 201 can use the registration code 511a to create a virtual counterpart 702b of the toy 301a in a virtual world 701 on the server 201. The scanning module 103a can read a registration code 511b from the article of apparel 122a and send the registration code 511b to the server 201. The server 201 can use the registration code 511b to create a virtual counterpart 702d of the article of apparel 122a in the virtual world 701 on the server 201.

The fastener 121 may include, for example, a snap, a magnet, a pin, an adhesive strip, a clamshell fixture, a spring clip, and so on.

The article of apparel 122a may include, for example, a shirt, pants, a skirt, a dress, a coat, a headband, a scarf, a necklace, a tie, a bandana, socks, shoes, sandals, a backpack, a purse, gloves, a vest, a choker, a mask, a fanny pack, slippers, underwear, a bra, a bikini, a swimsuit, exercise wear, a watchband, a bracelet, eyeglasses, earrings, earphones, a cell phone cover, a tablet cover, a hat, rain gear, an umbrella, boots, snow pants, skis, snowshoes, a glasses case, a handkerchief, and so on.

FIG. 1C is an illustrative block diagram of an embodiment of a system for registration and sharing of toys and apparel to create links in an online social network, and the design and manufacture of toys and apparel. A fastener 121 can be used to fasten a toy 301a to an article of apparel 122a. The owner 203a of the toy 301a may be able to use a device 210a to operate a design tool 131 on a server 201 to modify the design of the toy 301a and create a custom design 132. The custom design 132 can be used by a production process 133 to create a toy 301n. The toy 301n can be delivered to the owner 203a of the original toy 301a. The owner 203a of the article of apparel 122a may be able to use a device 210a to operate a design tool 131 on a server 201 to modify the design of the article of apparel 122a and create a custom design 132. The custom design 132 can be used by a production process 133 to create an article of apparel 122n. The article of apparel 122n can be delivered to the owner 203a of the original article of apparel 122a.

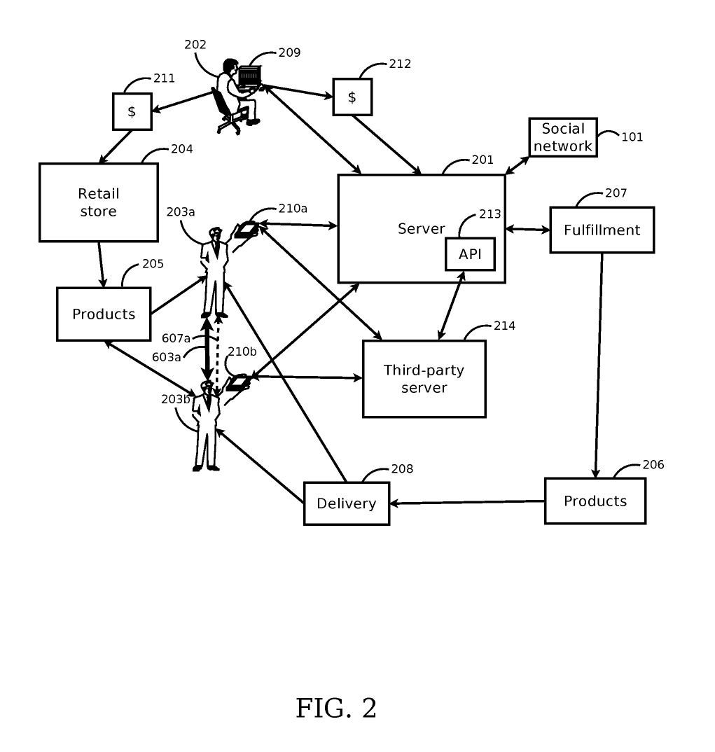

FIG. 2 is an illustrative block diagram of an embodiment of a system for facilitating the use and distribution of toys and apparel that can be used in the real world as well as in an online social network. A user 203a of the system, who may be a child, can use device 210a to access server 201. A person 202, who may be the parent of the user 203a, can make a physical purchase 211 at a retail store 204 of products 205 that may include toys and apparel. The person 202 can use a device 209 to access the server 201 to make an online purchase 212. A fulfillment process 207 can select the products 206 that were purchased online, and can use a delivery process 208 to provide the products 206 to the user 203a. The user 203a can use the products 205-206, for example, wearing the apparel and playing with the toys, and may register the products 205-206 on the server 201 using a device 210a. The user 203a can have a friend 203b, who can also acquire products 205 from a retail store 204 and who may also acquire products 206 through a delivery process 208. The user 203a and friend 203b can then trade 603a products with each other, and can register the trades on the server 201 using devices 210a-210b. The server 201 can track the ownership and travel of the products 205-206 through the initial registration of the products 205-206 and subsequent registration of the trade 603a. The server can create a link 607a in the social network 101 based on the trade 603a.

The communication between devices 209 and 210a-210b and the server 201 may be through a network. The network can include a local-area network (LAN), such as a company Intranet, a metropolitan area network (MAN), or a wide area network (WAN), such as the Internet or the World Wide Web. In some embodiments, there are multiple networks between the devices and the servers. In one of these embodiments, the network may be a public network, a private network, or may include combinations of public and private networks.

The network may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network may include a wireless link, such as an infrared channel or satellite band. The topology of the network may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some embodiments, different types of data may be transmitted via different protocols. In other embodiments, the same types of data may be transmitted via different protocols.

In one embodiment, the server 201 can provide an Application Programming Interface (API) 213 that can define programmatic access to the information and operations carried out by the server 201 in servicing interactions by devices 209 and 210a-210b. The API 213 can provide a third party server 214 with the ability to implement new functionality, such as new games, new toys, new apparel, and so on. The new functionality provided by the third party server 214 may facilitate making the products 205-206 more attractive to users 203a-203b by providing more options to the users 203a-203b.

The one or more servers associated with the server 201 or third party server 214 do not need to be physically proximate to each other or in the same machine farm. Thus, the servers logically grouped as a machine farm may be interconnected using a wide-area network (WAN) connection or a metropolitan-area network (MAN) connection. For example, a machine farm may include servers physically located in different continents or different regions of a continent, country, state, city, campus, or room. Data transmission speeds between servers in the machine farm can be increased if the servers are connected using a local-area network (LAN) connection or some form of direct connection.

Management of the servers may be de-centralized. For example, one or more servers may comprise components, subsystems and circuits to support one or more management services. In one of these embodiments, one or more servers provide functionality for management of dynamic data, including techniques for handling failover, data replication, and increasing robustness. Each server may communicate with a persistent store and, in some embodiments, with a dynamic store.

A server may include a file server, application server, web server, proxy server, appliance, network appliance, gateway, gateway, gateway server, virtualization server, deployment server, secure sockets layer virtual private network (“SSL VPN”) server, or firewall. In one embodiment, the server may be referred to as a remote machine or a node. In one embodiment, the server may be referred to as a cloud.

The system and its components, such as a server 201, third party server 214, device 209, devices 210a-210b, and modules 101, 213, 207, 206, and 208 may include hardware elements, such as one or more processors, logic devices, or circuits. For example, the system and its components may include a bus or other communication component for communicating information and a processor or processing circuit coupled to the bus for processing information. The hardware elements can also include one or more processors or processing circuits coupled to the bus for processing information. The system also includes main memory, such as a random access memory (RAM) or other dynamic storage device, coupled to the bus for storing information, and instructions to be executed by the processor. Main memory can also be used for storing position information, temporary variables, or other intermediate information during execution of instructions by the processor. The system may further include a read only memory (ROM) or other static storage device coupled to the bus for storing static information and instructions for the processor. A storage device, such as a solid state device, magnetic disk or optical disk, can be coupled to the bus for persistently storing information and instructions.

The system and its components, such as a server 201, third party server 214, device 209, devices 210a-210b, and modules 101, 213, 207, 206, and 208 may include, e.g., computing devices, desktop computers, laptop computers, notebook computers, mobile or portable computing devices, tablet computers, smartphones, personal digital assistants, or any other computing device.

According to various embodiments, the processes described herein can be implemented by the system or hardware components in response to the one or more processors executing an arrangement of instructions contained in memory. Such instructions can be read into memory from another computer-readable medium, such as a storage device. Execution of the arrangement of instructions contained in memory causes the system to perform the illustrative processes described herein. One or more processors in a multi-processing arrangement may also be employed to execute the instructions contained in memory. In alternative embodiments, hard-wired circuitry may be used in place of or in combination with software instructions to effect illustrative embodiments. Thus, embodiments are not limited to any specific combination of hardware circuitry and software. To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

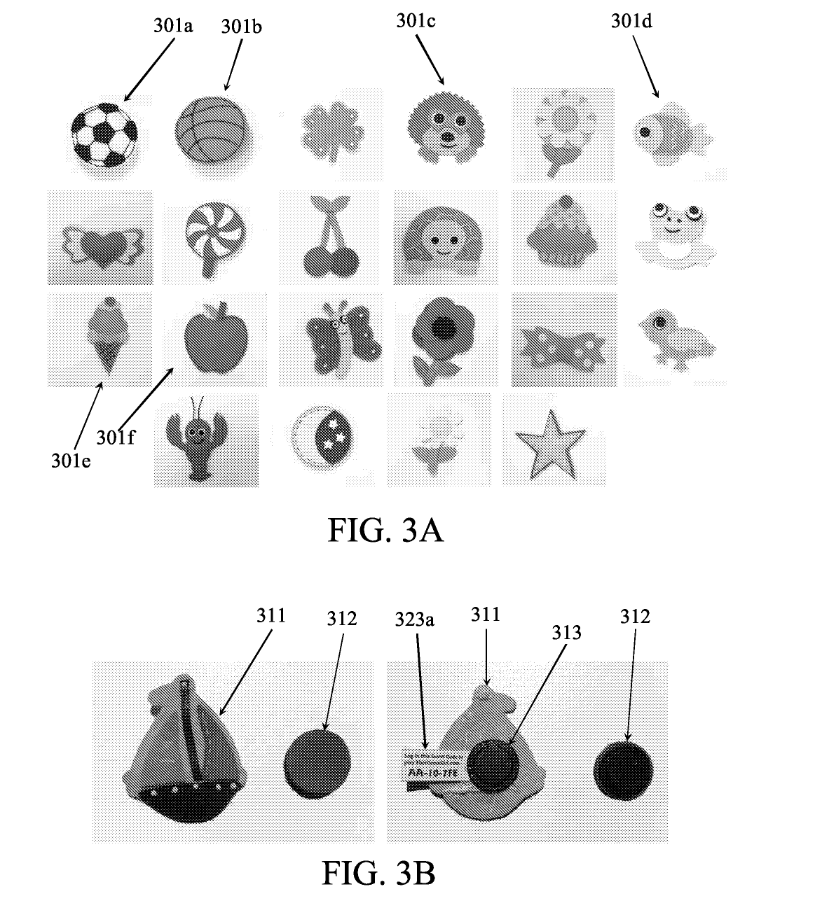

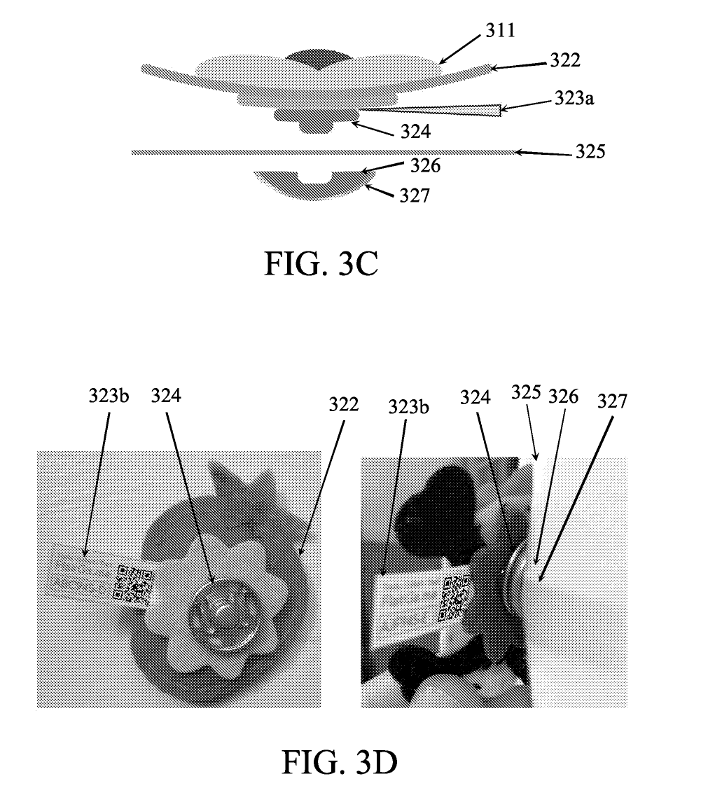

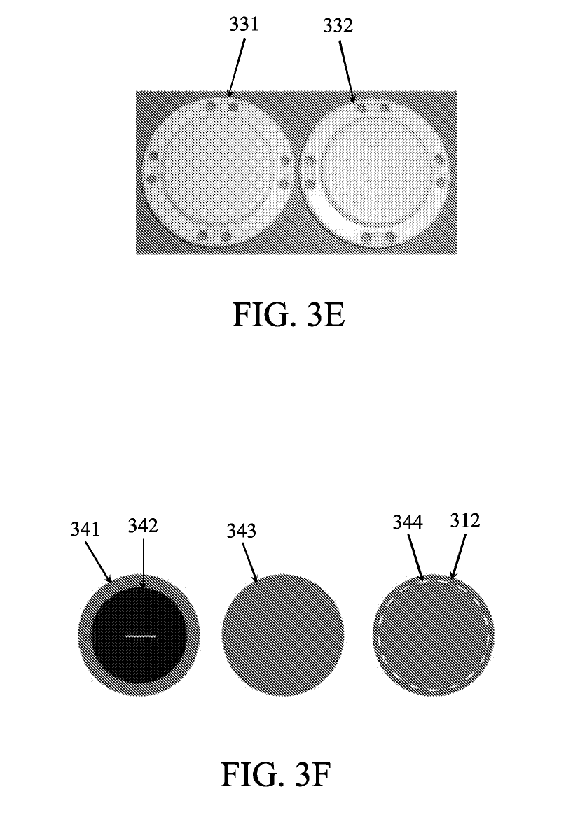

FIG. 3A is an illustrative image of an embodiment of toys that can be used in the real world. Each toy 301a-301f can have a distinctive visual design. The toys 301a-301f may have a variety of themes, for example 301a-301b can represent a sports theme, 301c-301d can represent an animal theme, and 301e-301f can represent a food theme. Each toy 301a-301f can be independent of the others, and may be sold and used separately.

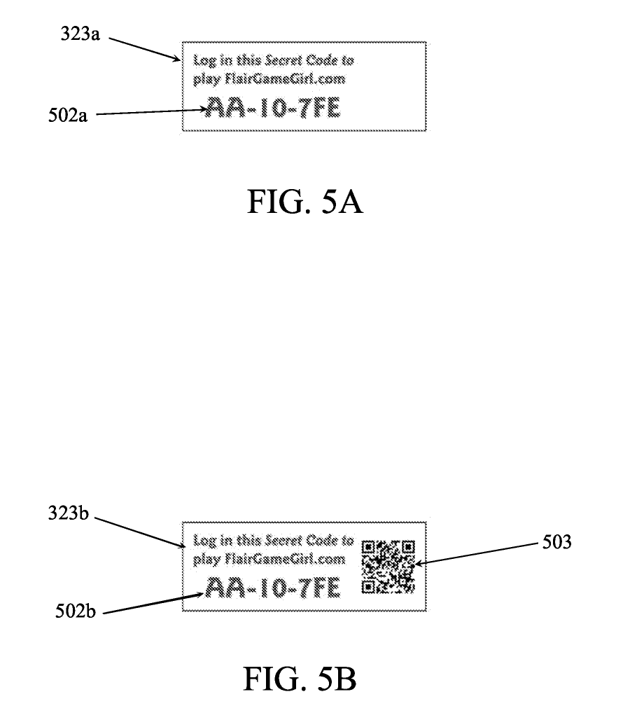

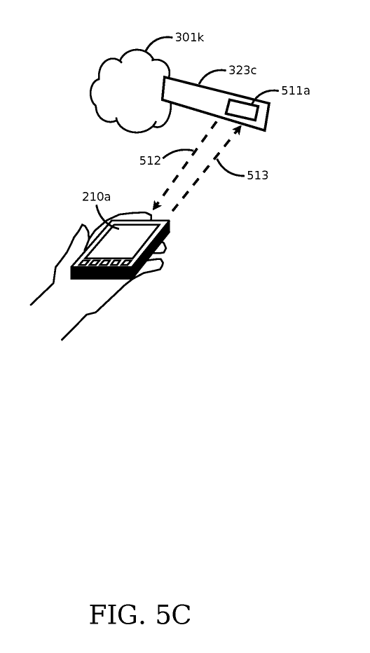

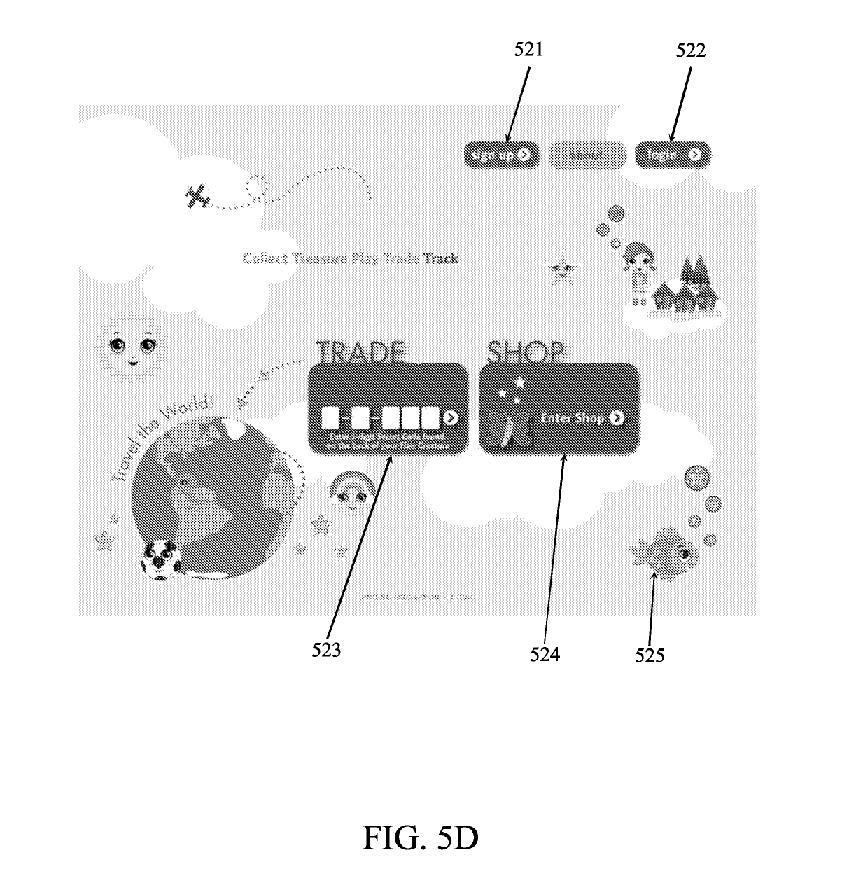

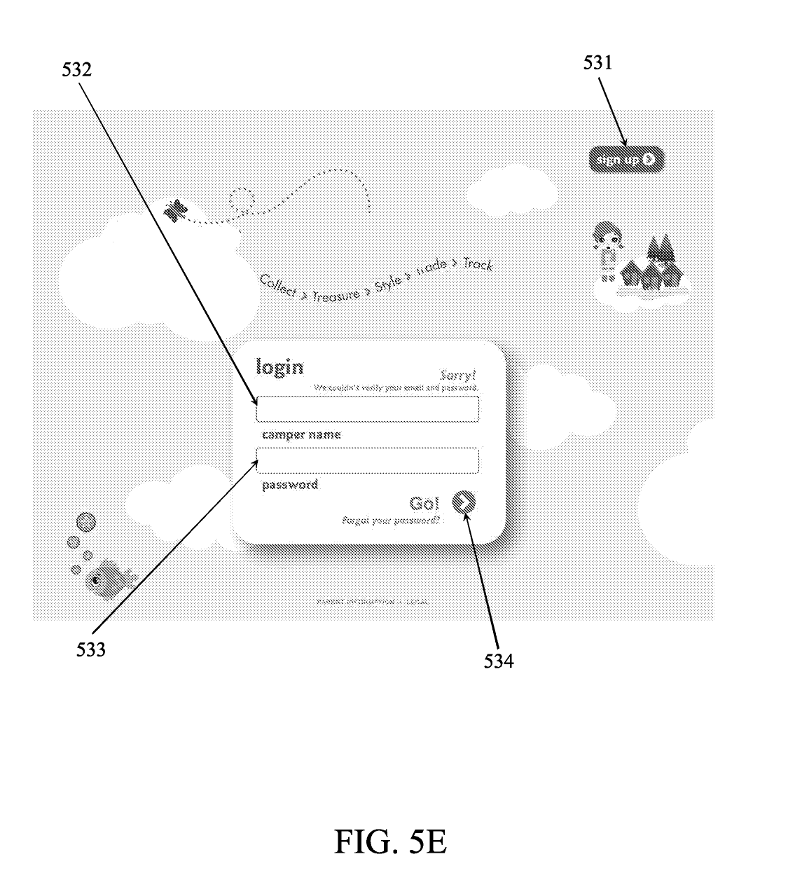

FIG. 3B is an illustrative image of an embodiment of a toy with a magnetic fastener that can attach it to an item of apparel. The main body of the toy 311 can be connected to a felt-covered magnet 313. Another backing piece 312 can be separate from the toy. The backing piece 312 may or may not be magnetic, it can be attracted by the magnet 313, and it may also be covered with felt. The fabric of an item of apparel can be placed between the felt-covered magnet 313 and the backing piece 312, with the main body of the toy 311 on the outside of the item of apparel. The magnet 313 and the backing piece 312 can attract each other and grip the fabric of the item of apparel, holding the main body of the toy 311 in place. The felt covering of the backing piece 312 can protect the skin of the wearer of the item of apparel and make it more comfortable. The toy can also have a tag 323a that can be used to register the toy on the server 201 as described more fully with respect to FIGS. 5A-D.

FIG. 3C is an illustrative diagram of an embodiment of a snap fastener that can attach a toy to an item of apparel. The main body of the toy 311 can be the decorative, graphic part displayed as shown with regards to FIG. 3A, so it can be the outermost part. Behind the main body 311 of the toy, a felt backing 322 can provide physical support as well as a visually pleasing background color for the toy. The tag 323a can be attached to the toy behind the felt backing 322 in a way that it may not be seen from the front. The tag 323a can be used to register the toy on the server 201 as described more fully with respect to FIGS. 5A-D. A male snap fastener 324 can be attached to the back side of the toy. A female snap fastener 326 can be provided separately. The female snap fastener may be attached to a felt backing 327. The fabric 325 of an item of apparel can be placed between the male snap fastener 324 and the female snap fastener 326, with the main body of the toy 311 on the outside of the item of apparel. The male snap fastener 324 and female snap fastener 326 can snap together and grip the fabric 325 of the item of apparel, holding the main body of the toy 311 in place. The felt backing 327 can protect the skin of the wearer of the item of apparel and may facilitate in making wearing the toy 311 more comfortable.

The male snap fastener 324 and the female snap fastener 326 can be a metallic pair designed as a unit to operate together, and may be manufactured by a third party such as YKK SNAP FASTENERS AMERICA of Lawrenceburg, Kentucky. In another embodiment, the male snap fastener 324 and the female snap fastener 326 can be a magnetic pair designed as a unit to operate together, and may be manufactured by a third party such as ROMAG FASTENERS, INC. of Orange, Connecticut.

FIG. 3D is an illustrative image of an embodiment of a toy being attached to an item of apparel. The tag 323b can be used to register the toy on the server 201 as described more fully with respect to FIGS. 5A-D. The fabric 325 of an item of apparel can be placed between the male snap fastener 324 and the female snap fastener 326 (not visible in FIG. 3D) with the felt backing 322 on the outside of the item of apparel. The male snap fastener 324 and female snap fastener 326 can snap together and grip the fabric 325 of the item of apparel, holding the toy in place. The felt backing 327 (not visible in FIG. 3D) can protect the skin of the wearer of the item of apparel and can facilitate in making wearing the toy 311 more comfortable.

FIG. 3E is an illustrative image of an embodiment of a magnet pair that can be used to attach a toy to an item of apparel. The magnet pair can consist of an outside magnet 331 and an inside magnet 332. The outside magnet can be used for the felt-covered magnet 313 as shown with respect to FIG. 3B. The inside magnet 332 can be used for the backing piece 312 as shown with respect to FIG. 3B. The magnets 331 and 332 can be manufactured by a third party such as K&J MAGNETICS, INC. of Jamison, Pa.

FIG. 3F is an illustrative diagram of an embodiment of a fabric enclosure that can be used around a magnet. The magnet 342 can be placed in between a front piece of felt 343 and a back piece of felt 341. The two pieces of felt can be sewn together with stitching 344. The resulting assembly 312 can be used as the backing piece 312 described with respect to FIG. 3B.

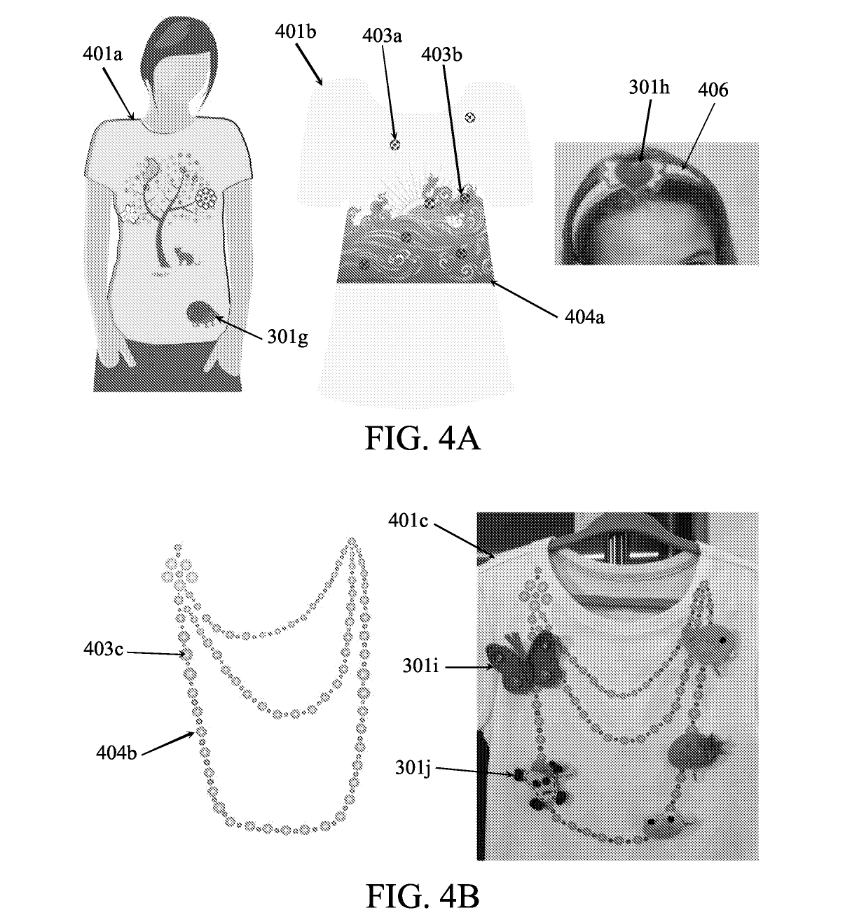

FIG. 4A is an illustrative image of an embodiment of items of apparel that can have a toy attached to them. The shirt 401a can have a toy 301g attached to it in a way that can fit in with the graphic theme of the print on the shirt 401a. The shirt 401b can have a graphic print 404a that may be designed in such a way that is suggestive of using an indicated toy 301a-301g in one part of the graphic print 404a. A marker 403a-403b can indicate a location where a toy 301a-301g may be suggested. In the example of FIG. 4A, marker 403a, which is in the sky in the graphic print 404a, may indicate a location where a toy resembling a bird may be appropriate, and marker 403b, which is on the surface of the water in the graphic print 404a, may indicate a location where a toy resembling a fish may be appropriate. A headband 406 may also be an item of apparel that can have a toy 301h attached to it.

FIG. 4B is an illustrative image of an embodiment of printing for an item of apparel that can be suggestive of positions for attaching toys. The graphic print 404b can be applied to a shirt 401c. The graphic print 404b can have a marker 403c that may indicate a suggested location for a toy 301a-301g, and a user 203a can attach a toy 301i at the suggested location 403c. The user 203a may also want to attach a toy 301j in a location based on personal preference.

FIG. 5A is an illustrative diagram of an embodiment of a tag that can be used on a toy, with an identifier that can be used to register the toy online. The tag 323a can be attached to the toy, and may have an identifier 502a printed on it. In the example of FIG. 5A, the identifier printed on the tag is AA-10-7FE. As described with respect to FIG. 2, a user 203a can use a device 210a to enter this identifier 502a on the server 201 in order to register the toy on the server 201.

FIG. 5B is an illustrative diagram of an embodiment of a tag that can be used on a toy, with a Quick Response (QR) code that can be used to register the toy online. The tag 323b can be attached to the toy, and may have an identifier 502b printed on it. The tag 323b may additionally have a QR code 503. As described with respect to FIG. 2, a user 203a can have a device 210a that may be capable of reading and interpreting QR codes, and may be able to use the device 210a to register the toy on the server 201 without any manual data entry. For example, the device 210a can be an IPHONE from APPLE COMPUTER of Cupertino, California, running the REDLASER application from EBAY of San Jose, California.

FIG. 5C is an illustrative block diagram of an embodiment of a toy with a Radio Frequency IDentification (RFID) tag that can be used to register the toy online A tag 323c can be attached to the toy 301k, and the tag 323c can have an embedded RFID tag 511a in it. The device 210a can be capable of reading the information in the RFID tag 511a by emitting a signal 513 and detecting the return signal 512 with the information modulating the return signal 512. A user 203a can use the device 210a in this way to register the toy on the server 201 without any manual data entry. For example, the device 210a can be an HTC ONE by HTC of Taipei, Taiwan, which can use its Near Field Communication (NFC) equipment to read RFID tags.

FIG. 5D is an illustrative example of an embodiment of a user interface that can be used to register a toy online. The interface can incorporate the toy theme by using graphics 525 that may be associated with the toys. A user 203a can create a user account 102a by using the “sign up” button 521 for a first visit, or the user 203a can sign in to an existing user account 102a by using the “login” button 522 for a repeat visit. The user 203a can shop for items in the retail store by using the “shop” link 524, even without signing in, although purchasing an item may require signing in. The user 203a may be able to register a toy manually by entering the identifier 502a printed on the tag 323a attached to the toy, as shown with respect to FIG. 3D and FIG. 5A, and using the “trade” link 523, with or without signing in. Registering a new toy may require signing in, but registering a trade may not require signing in, and the server 201 may be able to infer the correct user account using the identifier 502a of the toy.

FIG. 5E is an illustrative example of an embodiment of a user interface that can be used to access a user account 102a to register a toy online. The user 203a can sign in by entering a user name 532 and password 533, and selecting the “Go!” button 534. If the user 203a needs to create a user account for an initial visit, the “sign up” link 531 can be used.

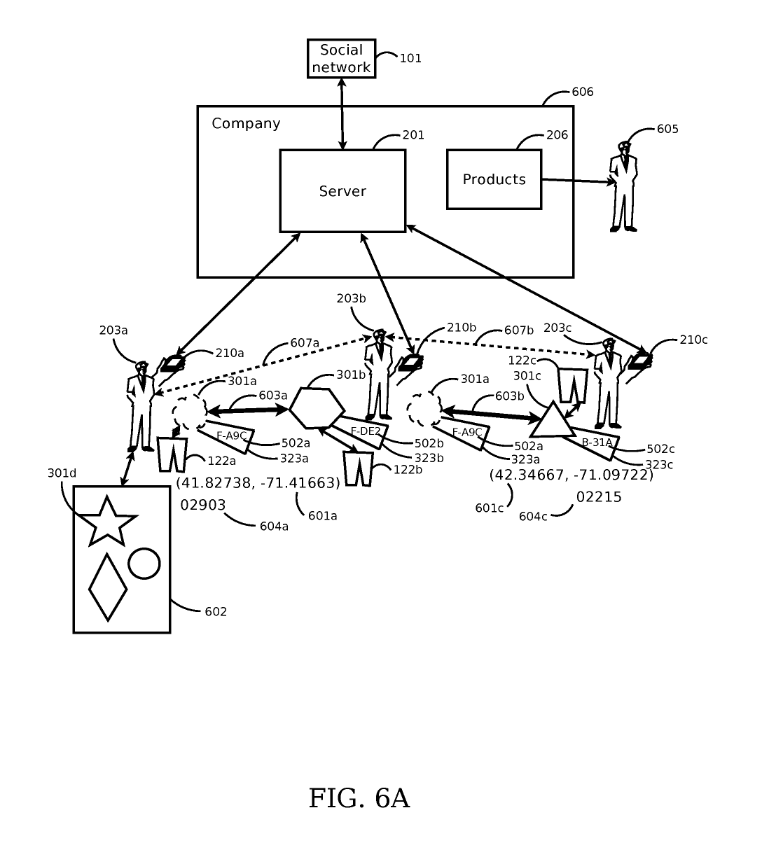

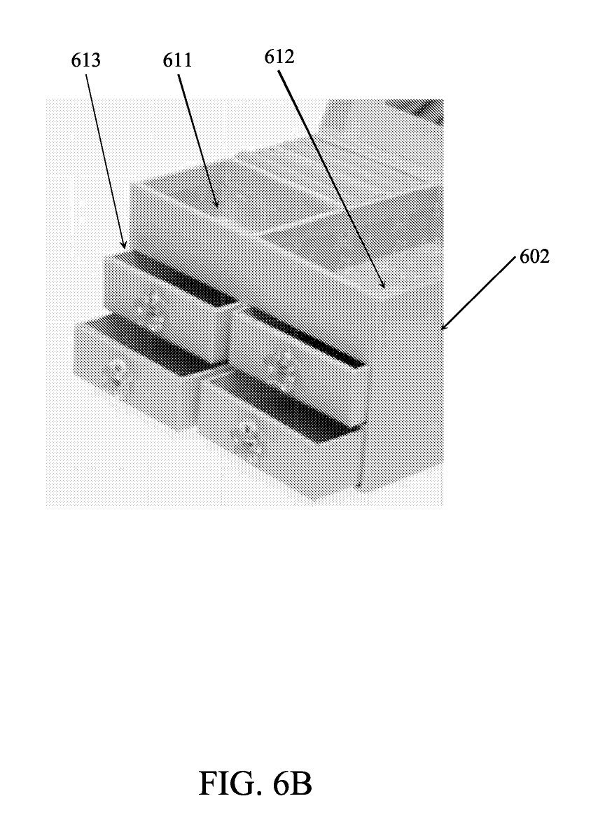

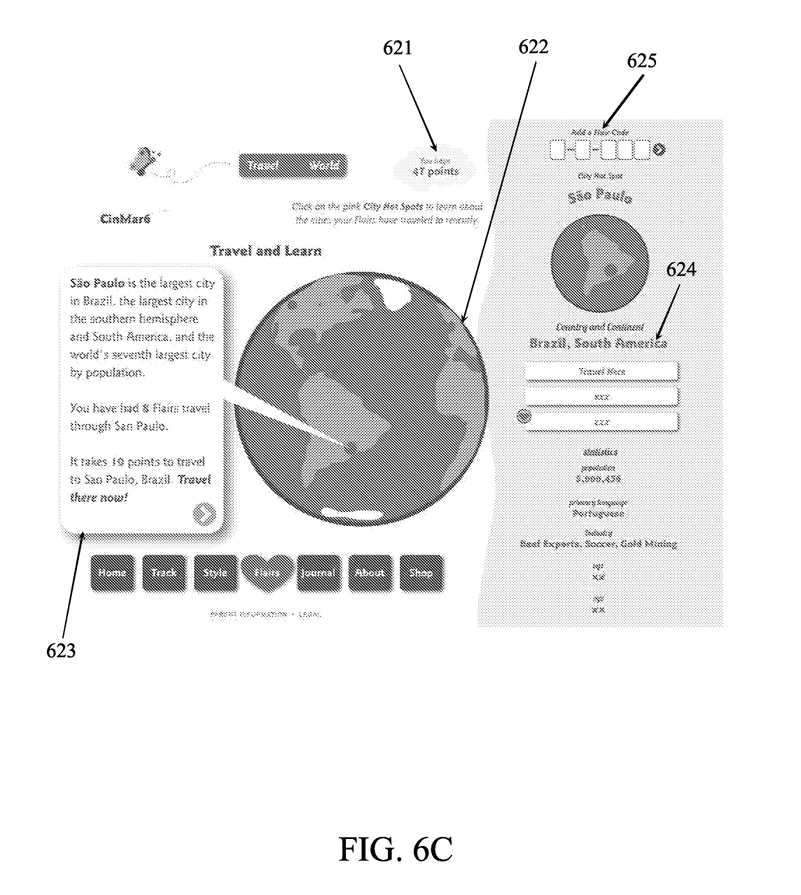

FIG. 6A is an illustrative block diagram of an embodiment of trading toys between individuals and tracking the trading. User 203a may have a toy 301a but may want toy 301b, and user 203b may have toy 301b but may want toy 301a. In one embodiment, user 203a may have an item of apparel 122a with a suggested attachment of toy 301b, and user 203b may have an item of apparel 122b with a suggested attachment of toy 301a, and this may be motivating the desire to trade. In another embodiment, user 203a may be collecting toys with the theme of toy 301b, and user 203b may be collecting toys with the theme of toy 301a, and this may be motivating the desire to trade. Users 203a and 203b may wish to do a trade 603a. User 203a can register the trade 603a on the server 201 by using device 210a to enter the identifier 502b on the tag 323b attached to toy 301b. User 203b can register the trade 603a on the server 201 by using device 210b to enter the identifier 502a on the tag 323a attached to toy 301a. The server 201 can recognize that a trade 603a has happened between user 203a and 203b, involving toys 301a and 301b, and can track the trade 603a. The server 201 can also update the ownership information to reflect the fact that user 203a now owns toy 301b, and that user 203b now owns toy 301a. The server 201 may keep track of the first user 203a to own a toy 301a after its original purchase, and permanently record that user 203a as the “parent” of the toy 301a.

Online registration of trades can require confirmation. For example, for trade 603a, the server 201 may require that user 203a register the desire to “trade away” toy 301a, in addition to requiring that user 203b register the receipt of toy 301a, before the server 201 will register the transfer of toy 301a from user 203a to user 203b. This may help to prevent theft or fraud by a malicious user 203b.

The server 201 may create or modify links 607a-607b in a social network 101 based on the trades 603a-603b. For example, the server 201 may create link 607a between user 203a and user 203b in the social network 101 based on the trade 603a. The server 201 may create link 607b between user 203b and user 203c in the social network 101 based on the trade 603b.

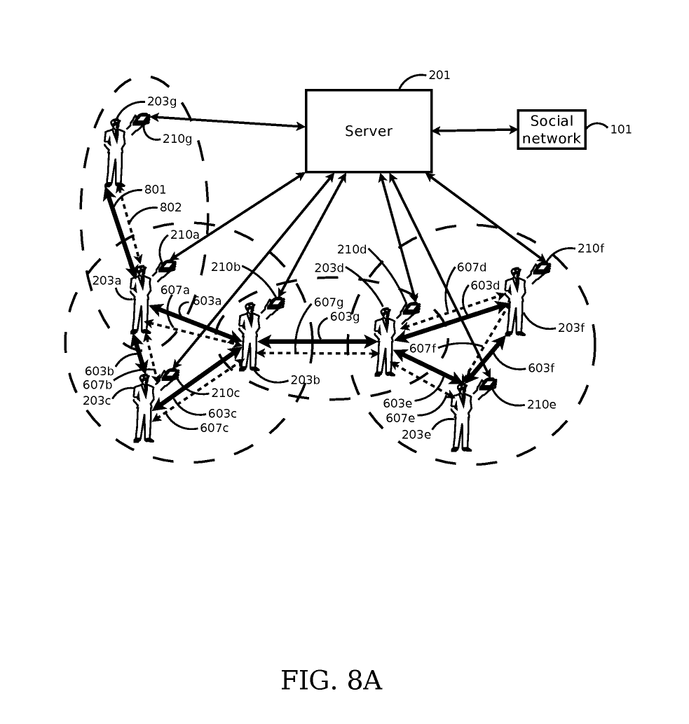

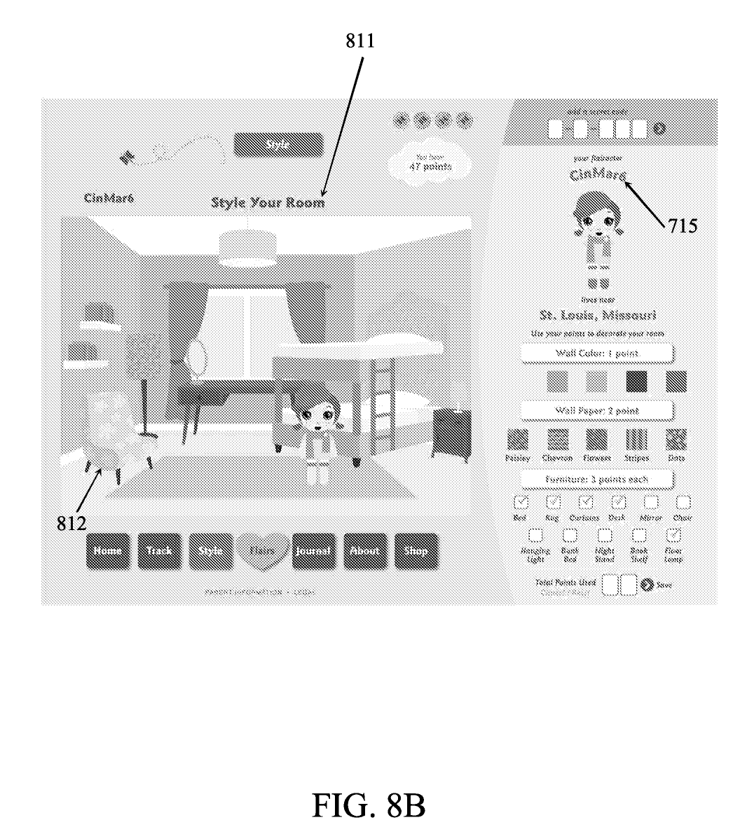

It should be understood that the trading described with respect to FIG. 6A is not limited to the exchange of two toys. In one embodiment, a trade may involve exchanging a toy for another item of value, such as a book. In another embodiment, a trade may involve exchanging a toy for currency (a sale). In still another embodiment, a trade may not be an exchange at all, but may be a gift transaction of a toy from one individual to another individual. In still another embodiment, a trade may not involve exchanging two toys, but may instead be an exchange of the registration codes of the toys as described with respect to FIG. 1A, while maintaining possession of the original toys (sharing). These embodiments can also apply to trades such as 603a described with respect to FIG. 2, and trades such as 603a-603g and 801 described with respect to FIG. 8A.

Continuing with FIG. 6A, user 203b may want toy 301c, and may be willing to trade toy 301a for it. User 203c may own toy 301c and may be willing to trade toy 301a for it. The reasons motivating the trade may be similar to the reasons that motivated trade 603a. Users 203b and 203c can do a trade 603b to exchange toys 301a and 301c. User 203b can register the trade 603b on the server 201 by using device 210b to enter the identifier 502c on the tag 323c attached to toy 301c. User 203c can register the trade 603b on the server 201 by using device 210c to enter the identifier 502a on the tag 323a attached to toy 301a. The server 201 can recognize that a trade 603b has happened between user 203b and 203c, involving toys 301a and 301c, and can track the trade 603b. The server 201 can also update the ownership information to reflect the fact that user 203b now owns toy 301c, and that user 203c now owns toy 301a.

The server 201 can track the fact that toy 301a has been traded twice and has changed ownership from user 203a to user 203b, and then changed ownership to user 203c. Devices 210a-210c may support location services that enable them to send location information 604a-604c of users 203a-203c to the server 201. For example, device 210a may be able to send a latitude-longitude pair 601a to server 201 indicating the position of user 203a, and device 210c may be able to send a latitude-longitude pair 601c to server 201 indicating the position of user 203c. The server 201 may then be able to track the movement of toy 301a as it is traded to new owners in different locations. This may be a benefit to the users 203a-203c, who may find value in following the travel of their toys as they are traded.

The operating system of the devices 210a-210c may provide location and orientation services so that application programs can find out the orientation and position of the device in three-dimensional space. These services may also provide the velocity or acceleration of the device as well. The location and orientation services can use several mechanisms built into the device in order to provide the best information available. In one embodiment, the devices 210a-201c may have Global Positioning System (GPS) antennas, which can receive signals from one or more satellites in the GPS system. The differences in timing of the signals can allow the devices 210a-210c to determine their positions and elevations on the Earth within about 10 meters or more, depending on how many signals are available and the strength of the signals. In one embodiment, the devices 210a-210c may have WiFi antennas, which can send and receive signals to and from local wireless data access points. The devices 210a-210c may be able to use the relative strengths of the WiFi signals, the Media Access Control (MAC) addresses of the WiFi signals, the identification of the access points using the MAC addresses, and a lookup of the positions of the access points in a database, to facilitate determining the position of the device on the Earth within a few tens of meters or more, depending on how many WiFi signals are available and whether the access points are in the database. In one embodiment, the devices 210a-210c may have cellular antennas, which can send and receive signals to and from cell towers for voice and data communications. The devices 210a-210c may be able to use the relative strengths of the signals, the identification of the cell towers, and a lookup of the positions of the cell towers in a database, to facilitate determining the position of the device on the Earth within a few tens of meters or more, depending on how many signals are available. In one embodiment, the devices 210a-210c may have built-in accelerometers or built-in gyroscopes, which can provide the acceleration, velocity, and position of the devices 210a-210c in three-dimensional space. The accelerometers or gyroscopes may utilize Micro ElectroMechanical System (MEMS) circuits. The information from the accelerometers or gyroscopes may provide relative movement information of the devices 210a-210c to within a few centimeters or even millimeters, depending on the accelerometers and gyroscopes, and the nature of the movement of the devices 210a-210c. The capabilities of the devices 210a-210c described here may be used separately or together to facilitate tracking of the position and orientation of the devices 210a-210c.

There may be a desire, or even a legal restriction, to avoid exact location tracking of users 203a-203c, especially if the users 203a-203c may be children. The server 201 or devices 210a-210c may instead represent the location of the users 203a-203c as rough geographical indicators such as the Zone Improvement Plan (ZIP) codes 604a-604c of the US Postal Service. For example, the latitude-longitude pair 601a representing the location of user 203a may be converted to a ZIP code 604a, and the latitude-longitude pair 601c representing the location of user 203c may be converted to a ZIP code 604c. Other methods of reducing the resolution of the location information may also be used.

The social network 101 may weight the links 607a-607b differently based upon the location information 601a-601c. For example, the link 607a might be weighted more heavily than the link 607b if devices 210a and 210b are normally closer together than devices 210b and 210c. The weighting on the links 607a-607b may be updated as the location information 601a-601c changes.

Users 203a-203c may decide that they want to collect certain toys 301a-301d, and keep them rather than trading them. The users may be able to use a storage box 602 that may be designed to store and display toys such as 301d, and keep toys 301a-301d in the storage box 602.

Users 203a-203c may have the option to donate products 206 to a person 605 who may not be able to afford the products 206. This charitable activity may be funded by direct monetary donations, or may be provided by a company 606 as a reward for gaming or other activities that are accomplished on the server 201 by the users 203a-203c.

Users 203a-203c may have articles of apparel 122a-122c to which toys 301a-301d may be attached. As described with respect to FIG. 1B, the articles of apparel 122a-122c may have registration codes 511a-511b on them that may enable them to be registered on the server 201. The registration codes 511a-511b may provide information about characteristics of the articles of apparel 122a-122c such as styles, themes, colors, sizes, materials, and so on. The social network 101 may use these characteristics to weight the links 607a-607b more or less heavily. For example, the social network 101 may weight the link 607a more heavily if the articles of apparel 122a and 122b have the same theme, since the two users 203a and 203b may share a common interest in that theme. The social network 101 may also make recommendations based on the articles of apparel 122a-122c and the toys 301a-301d. For example, if user 203a has a toy 301d that is designed to attach to article of apparel 122b in an aesthetically pleasing way, the social network 101 may make a recommendation to users 203a and 203b that 203b may be interested in trading in exchange for receiving toy 301d.

FIG. 6B is an illustrative image of an embodiment of a storage box that can be used for toys. The storage box 602 can have drawers 613 for organizing toys 301a-301d as described with respect to FIG. 6A. The storage areas can have fasteners for attaching the toys 301a-301d to the sides 611 and bottom 612 of the storage areas.

The storage box 602 may be able to determine which toys 301a-301d are stored in it. For example, the storage box 602 may use the same scanning mechanisms as described with respect to FIG. 5B and FIG. 5C. The storage box 602 may be able to use this measurement to record the usage patterns of the toys 301a-301d stored in the storage box 602. The storage box 602 may be able to transmit this usage information to the server 201, and the social network 101 may be able to use this usage information to weight the links 607a-607g between the users 203a-203f. For example, the social network 101 may weight a link 607a-607g between two users 203a-203f if it was originally formed by a trade 603a-603g of two toys 301a-301d that both are used frequently, as measured by the storage box 602 in measuring that the two toys 301a-301d are removed from and returned to the storage box 602 frequently.

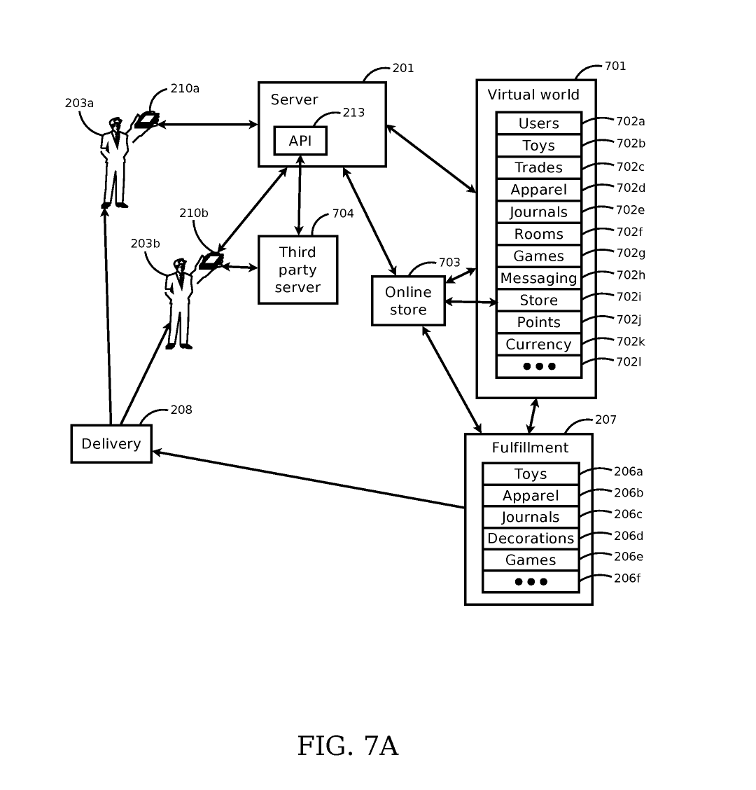

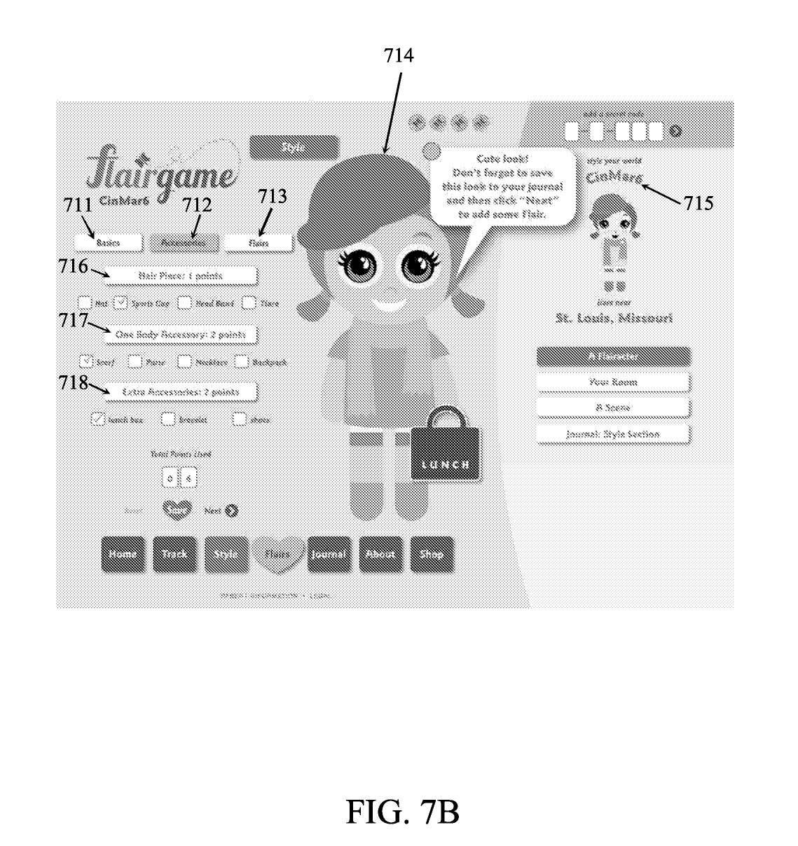

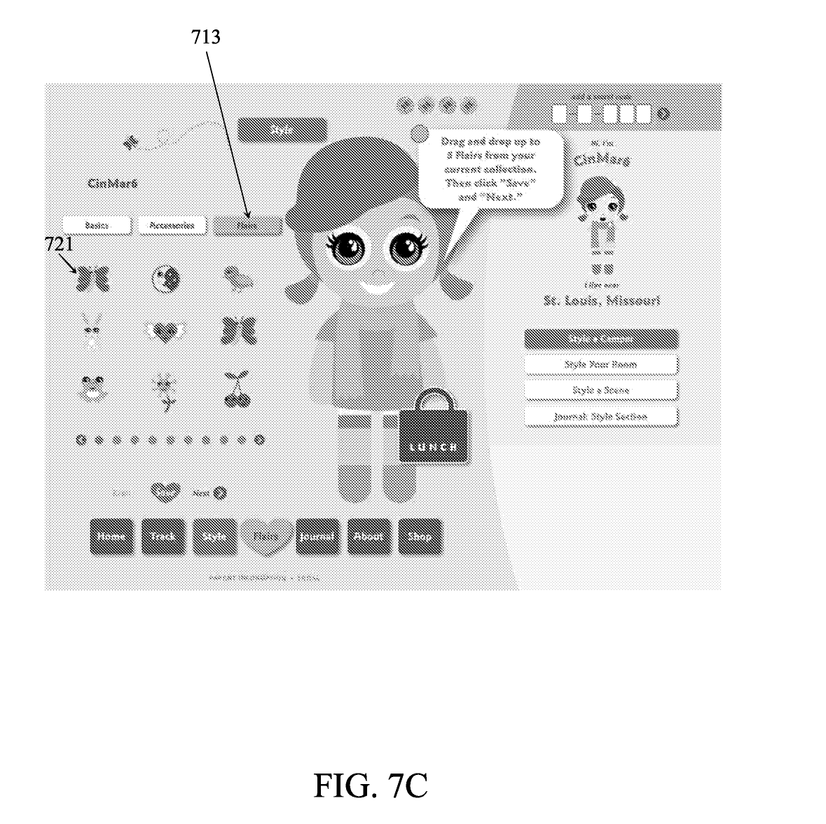

FIG. 6C is an illustrative example of an embodiment of a user interface that can be used to track the trading activity of a toy. As shown with respect to FIG. 6A and FIG. 7A, a user 203a can accumulate points 702j every time a toy 301a-301d that has been owned by the user 203a travels as the result of a trade 603a-603b. The interface can show the number of points 621 that the user 203a has accumulated from travel. The interface can show a map 622 of travel areas of the toys 301a-301d of the user 203a. The interface can highlight areas 623 where toys 301a-301d have traveled, and can provide more detailed information 624 about the areas 623. If a user 203a wants to see where a specific toy 301a has traveled, the user 203a can enter the identifier 502a for the toy 301a into the interface 625 to view specific information about that toy 301a.

FIG. 7A is an illustrative block diagram of an embodiment of a virtual world. User 203a can interact with the server 201 using device 210a. The server 201 can present aspects of a virtual world 701 to the user 203a that may provide an engaging and entertaining experience, and may entice the user 203a to use the online store 703 to purchase more products. The virtual world 701 can present many aspects 702a-702l to help make a rich experience for the user 203a.

The virtual world 701 can contain other users 702a that can interact with the user 203a. The users 702a can be representations of other actual users 203b of the system, or they may be computer-generated characters that respond to the user 203a. The users 203a-203b may be able to see graphic representations of the other users 702a in the virtual world, which may be called avatars.

The virtual world 701 can contain virtual toys 702b that the user 203a can interact with. The virtual toys 702b can be representations of toys 301a-301d that exist in the real world, or they may be representations of toys that only exist in the virtual world 701. The user 203a may only have access to toys that have been acquired in either the real world or the virtual world 701. The user 203a may be able to carry and store virtual toys 702b in the virtual world 701, and may be able to trade virtual toys 702b with virtual trades 702c, attach virtual toys 702b to virtual apparel 702d, display virtual toys 702b in virtual rooms 702f, play virtual games 702g with virtual toys 702b, purchase virtual toys 702b in a virtual store 702i, and other activities, all which may be in the virtual world 701.

The virtual world 701 can allow the user 203a to virtually trade 702c. The user 203a may be able to trade virtual toys 702b with other users 702a in the virtual world 701. When the user 203a trades a toy with another user 203b in the real world, a corresponding virtual trade 702c may also happen in the virtual world 701. The virtual world 701 may support virtual trades 702c of items other than virtual toys 702b, such as virtual apparel 702d, items in virtual rooms 702f, information or tokens in virtual games 702g, and so on. The virtual world 701 may contain a virtual currency 702k so that virtual trades 702c do not need to be limited to purely bartering transactions, but may also have a currency component. The virtual world may allow virtual trades 702c to be gift transactions involving the transfer of a virtual item 702a-702l from one user 203a to another user 203b.

The virtual world 701 can contain virtual apparel 702d. The users 702a in the virtual world 701 may be able to wear the virtual apparel 702d. The user 203a may be able to attach virtual toys 702b to the virtual apparel 702d in the virtual world 701. The virtual apparel 702d in the virtual world may correspond to apparel that is available in the real world, or it may be a representation of apparel that only exists in the virtual world 701.

The virtual world 701 can contain virtual journals 702e that can belong to the user 203a. The user 203a may be able to make entries in the virtual journals 702e that can include text, images, audio, video, links, or other types of entries. The user 203a may be able to share sections of virtual journals 702e with other users 702a, and may be able to set permissions that control which other users 702a are able to view or edit sections of virtual journals 702e. The user 203a may be able to download and print a copy of a virtual journal 702e in the real world.

The virtual world 701 can contain virtual rooms 702f. The user 203a may be able to visit the virtual rooms 702f. The virtual rooms may have other users 702a in them, and the user 203a may be able to interact with other users 702a in the virtual rooms 702f. The user 203a may be able to decorate the virtual rooms 702f using virtual toys 702b, virtual apparel 702d, items from the virtual store 702i, or other items in the virtual world 701. The user 203a may be able to transact virtual trades 702c with other users 702a in the virtual rooms 702f.

The virtual world 701 can contain virtual games 702g. A virtual game 702g may contain or use other items 702a-7021 in the virtual world 701, and may take place directly in the virtual world 701. A virtual game 702g may appear to be a self-contained game that is played by a virtual user 702a in the virtual world 701, for example, it can appear that the virtual user 702a is using a virtual game system to play the virtual game 702g. A virtual game 702g may be a single-player game, or it may involve game play by multiple users 203a-203b. A virtual game 702g may involve game play by users that are controlled programmatically rather than by an actual user 203a-203b. A virtual game 702g may correspond to a game that exists in the real world. A virtual game 702g may correspond to a game that is played online on another server. A virtual game 702g may involve expenses or rewards that are transacted in a virtual currency 702k, or may involve expenses or rewards that are other items 702a-702l in the virtual world such as virtual toys 702b, virtual apparel 702d, or other virtual items 702a-702l.

The virtual world 701 can contain virtual messaging 702h. The user 203a may be able to send and receive messages to and from other users 203b. The messages may contain different types of content, such as text, audio, video, or links. The messages may be transacted in real time, and may be referred to as chat. The messages may be transacted in a store-and-forward architecture similar to that of email. The messages may be filtered for content or may be restricted to stylized messages from a preset list of options. The messages may have parental monitoring and controls that can be applied. The messages may be limited to a subset of the users 203a-203b using the system.

The virtual world 701 can contain a virtual store 702i. The virtual store 702i can be a graphical interface to an online store 703 that can provide an experience similar to that of shopping in a retail store in the real world. The virtual store 702i may have virtual shelves of items that are available for purchase and may allow the user 203a to select virtual items from the virtual shelves. The virtual store 702i may have a virtual cashier where purchases are finalized on the virtual items selected from the virtual shelves. The virtual store 702i may permit purchases to be made using a virtual currency 702k. The virtual store 702i may permit purchases to be made using trades of other items 702a-702l in the virtual world 701 such as toys 702b, apparel 702d, or other items 702a-702l. The virtual store 702i may permit purchases to be made with actual money using an online financial transaction. The virtual store 702i may have parental controls that allow restrictions on the type or amount of transactions for a user 203a. The virtual store 702i may allow virtual items 702a-702l to be gifted to a user 203a-203b, for example, as part of a promotional activity.

The virtual world 701 can contain points 702j. The points 702j may serve as a virtual currency 702k, or may be a separate entity that can be exchanged for virtual currency 702k. Points 702j may be rewarded to users 203a-203b for specific activities, in order to encourage the users 203a-203b to try more activities in the virtual world 701. For example, points 702j may be awarded to a user 203a-203b in return for completing the first trade of a real toy 301a-301d or a virtual toy 702b after purchasing the real toy 301a-301d or a virtual toy 702b. The store 702i may allow the use of points 702j to make a purchase. The virtual world 701 may allow users 203a-203b to use points 702j to make virtual trades 702c.

The virtual world 701 may contain other types of virtual items 7021 not listed here. The architecture of the virtual world 701 is designed to allow the addition of other virtual items 702l and the extension of the functions of existing virtual items 702a-702k.

The server 201 can provide external access to all data and functionality in the virtual world 701 through an API 213. This may allow a third party server 704 to add features and functionality to the virtual world 701. It may allow a third party server 704 to interface another virtual world or game interface with the virtual world 701. Another user 203b may find the enhancements provided by the third party server 704 attractive, and may prefer to use the third party server 704 through a device 210b to use the virtual world 701.

The server 201 can have an online store 703. User 203a can use a device 210a to access the online store 703 through the server 201. User 203b can use a device 210b to access the online store 703 through the server 201, using a third party server 704 that uses an API 213 for the access. User 203b may also be able to use a device 210b to access the online store 703 directly through the server 201. The online store 703 can be accessed from within the virtual world 701 using a virtual store 702i. The online store 703 may allow purchases of products 206a-206f. The online store 703 may permit purchases to be made using a virtual currency 702k. The online store 703 may permit purchases to be made using trades of other items 702a-702l in the virtual world 701 such as toys 702b, apparel 702d, or other items 702a-702l . The online store 703 may permit purchases to be made with actual money using an online financial transaction. The online store 703 may have parental controls that allow restrictions on the type or amount of transactions for a user 203a.

When products 206a-206f are purchased in the online store 703, a fulfillment process 207 may be used to prepare the products 206a-206f for delivery 208. The products may include toys 206a, apparel 206b, journals 206c, decorations 206d, games 206e, and other kinds of products 206f. In the real world, the products 206a-206f can be delivered 208 to users 203a-203b. Items 702a-7021 in the virtual world 701 may be used for merchandising opportunities in the products 206a-206f, and virtual counterparts of products 206a-206f can be included in the virtual world 701.

FIG. 7B is an illustrative example of an embodiment of a user interface that can be used to customize a character in a virtual world. A user 203a-203b as shown with respect to FIG. 7A may have a graphical representation in the virtual world 701 that may be called an avatar. The user 203a-203b may wish to customize the appearance of the avatar, and the user interface of FIG. 7B can facilitate the customization. Display 714 can show the current appearance of the avatar. Section 715 can show information about the avatar that can be viewed by other users 203a-203b. The user 203a-203b can customize basic features 711, accessories 712, toy attachments 713, and so on. In the example of FIG. 7B, the customizations of accessories 712 can include a hair piece 716, a body accessory 717, an extra accessory 718, and so on.

FIG. 7C is an illustrative example of an embodiment of a user interface that can be used to attach virtual toys to virtual apparel on a character in a virtual world. Continuing the example of FIG. 7B, the user may select 713 to customize the avatar with toy attachments, and may select a toy 721 to attach to the avatar.

FIG. 8A is an illustrative block diagram of an embodiment of an online social network. When users 203a-203f do trades 603a-603g with each other, they may register the trades 603a-603g on the server 201 using devices 210a-210f, and the server may use the connections between the users 203a-203f to set up links 607a-607g in a social network 101. In the example shown in FIG. 8A, user 203a may trade 603a with user 203b, forming a link 607a in the social network 101 between user 203a and user 203b. Continuing the example, user 203a may trade 603b with user 203c, forming a link 607b between user 203a and user 203c in the social network 101. Users 203b and 203c may know each other in the real world, or the two users may find out about each other through the social network 101. User 203b may trade 603c with user 203c, forming a link 607c between user 203b and user 203c in the social network 101.

Continuing the example of FIG. 8A, user 203d may trade 603d with user 203f, forming a link 607d between user 203d and user 203f in the social network 101. User 203d may trade 603e with user 203e, forming a link 607e between user 203d and user 203e in the social network 101. Users 203e and 203f may know each other in the real world, or the two users may find out about each other through the social network 101. User 203e may trade 603f with user 203f, forming a link 607f between user 203e and user 203f in the social network 101.

Continuing the example of FIG. 8A, user 203b may trade 603g with user 203d, forming a link 607g between user 203b and user 203d in the social network 101. This can introduce new connections in the social graph. For example, user 203e may now have a “friend of a friend” connection to user 203b, and user 203f may now have a “friend of a friend of a friend” connection to user 203a. The different connections in the social graph may control the information that is available to one user 203a-203f about another user 203a-203f.

The social network 101 may also support social connections that are not based on trading in the real world. In the example of FIG. 8A, user 203a and user 203g may have done a virtual trade 801 online, in the virtual world 701. Users 203a and 203g may have met each other in the virtual world 701, and they may not be physically close enough to know each other in the real world. The server 201 may treat the virtual trade 801 differently from a physical trade 603a-603g and may set up a “virtual friend” connection 802 in the social network 101 between users 203a and 203g. The “virtual friend” connection 802 may be treated differently from a “friend” connection 607a-607g, and may have different controls on the information available to users 203a-203g that are connected with a “virtual friend” connection.

FIG. 8B is an illustrative example of an embodiment of a user interface that can be used to interact between members of an online social network. The display 715 may show information about a user 203a that is visible to other users 203a-203g in the social network. The display 715 may show more or less information about the user 203a, depending on what type of “friend” connection the viewer has to the user 203a. The avatar of the user 203a may appear in a room 811 along with the avatars of other users 203a-203g that have a “friend” connection and have chosen to appear in the room 811. The users may be able to choose their location in the room 811. In the example of FIG. 8B, a user 203a may choose to sit in a chair 812. The users 203a-203g may communicate with each other using an immediate channel, which may be called a chat. The users 203a-203g may communicate with each other using a store-and-view mechanism similar to that found in other social networks like that of FACEBOOK, INC. of Palo Alto, Calif. The communications may include multiple forms of communication such as text, audio, video, links, and so on.

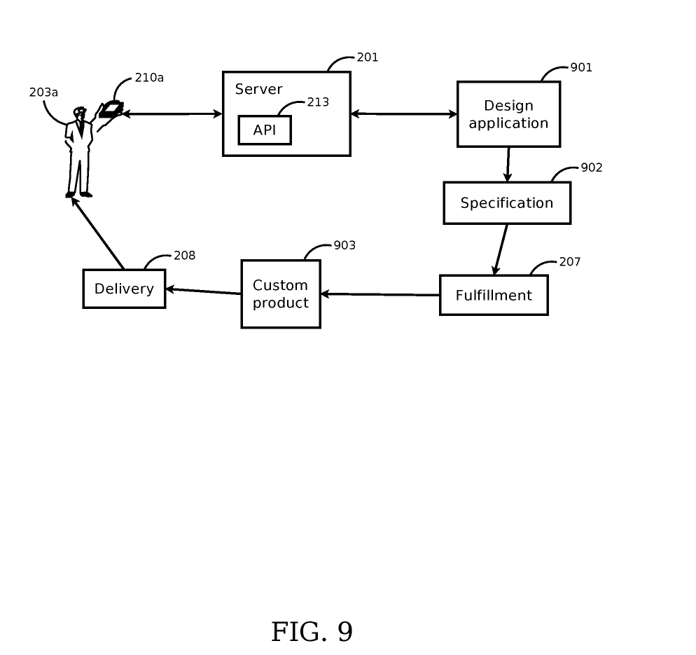

FIG. 9 is an illustrative block diagram of an embodiment of a system that can support an online user designing a virtual product that can then be created as a real world product. The user 203a may use a device 210a to access the server 201. The server 201 may provide a design application 901 that allows the user 203a to design or customize a product 206a-206f as shown with respect to FIG. 7A such as a toy 206a, item of apparel 206b, journal 206c, decoration 206d, game 206e, or other product 206f. The design application 901 may allow full customization, or may be simplified to support use by a child, or may have multiple use modes available. For example, customization may allow the applying an image to the product, changing the color scheme, selecting patterns used for backgrounds, and so on. Customization may allow incorporating avatars from the virtual world or the social network. The result of using the design application 901 may be a specification 902 for manufacturing a custom product 903. This specification 902 may enter the fulfillment process 207 and result in the creation of a custom product 903 that can then be delivered 208 to the user 203a.

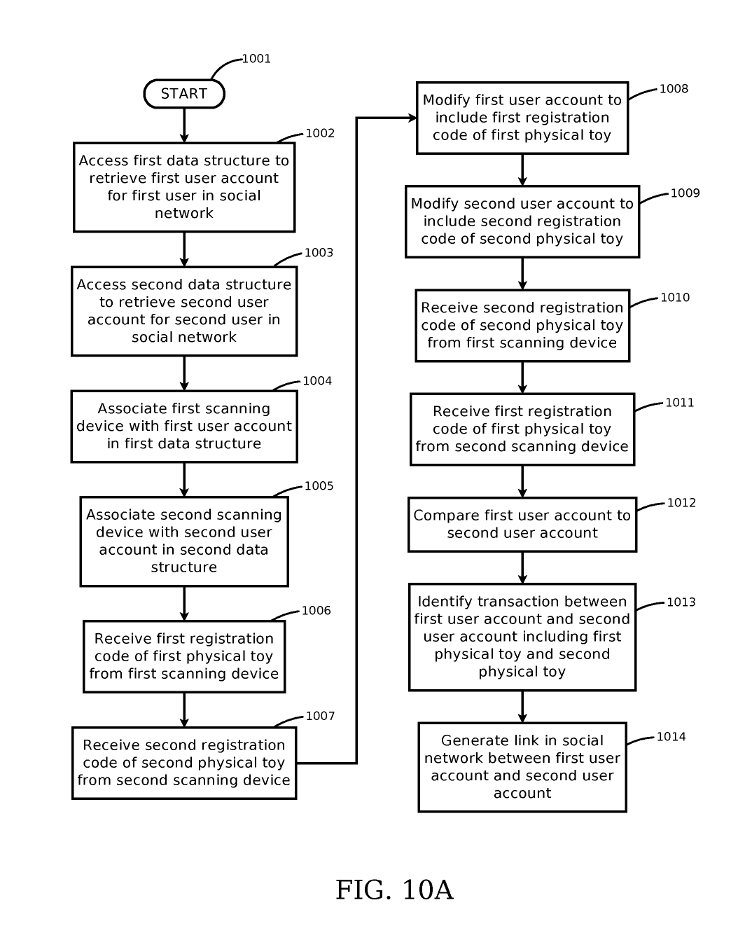

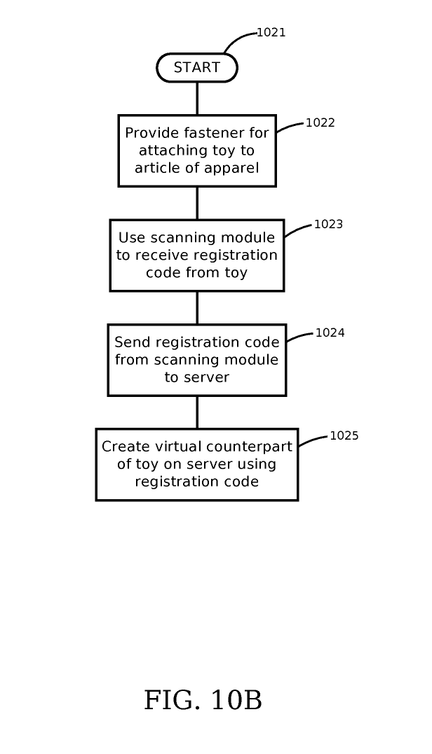

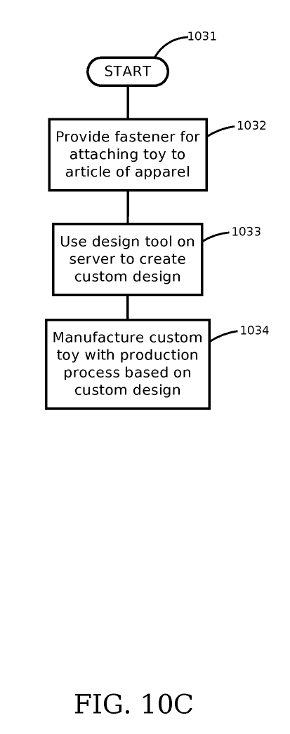

FIG. 10A is an illustrative flowchart depicting an example embodiment of a method of registering and sharing toys and apparel and creating links in an online social network. The method 1001 can include accessing a first data structure to retrieve a first user account for a first user in a social network (1002). The method 1001 can include accessing a second data structure to retrieve a second user account for a second user in the social network (1003). The method 1001 can include associating a first scanning device with the first user account in the first data structure (1004). The method 1001 can include associating a second scanning device with the second user account in the second data structure (1005). The method 1001 can include receiving a first registration code of a first physical toy from the first scanning device (1006). The method 1001 can include receiving a second registration code of a second physical toy from the second scanning device (1007). The method 1001 can include modifying the first user account to include the first registration code of the first physical toy (1008). The method 1001 can include modifying the second user account to include the second registration code of the second physical toy (1009). The method 1001 can include receiving the second registration code of the second physical toy from the first scanning device (1010). The method 1001 can include receiving the first registration code of the first physical toy from the second scanning device (1011). The method 1001 can include comparing the first user account to the second user account (1012). The method 1001 can include identifying a transaction between the first user account and the second user account including the first physical toy and the second physical toy (1013). The method 1001 can include generating a link in the social network between the first user account and the second user account (1014).

FIG. 10B is an illustrative flowchart depicting an example embodiment of a method of registering and sharing toys and apparel and creating links in an online social network, and creating virtual counterparts of the toys and apparel. The method 1021 can include providing a fastener for attaching a toy to an article of apparel (1022). The method 1021 can include using a scanning module to receive a registration code from the toy (1023). The method 1021 can include sending the registration code from the scanning module to the server (1024). The method 1021 can include creating a virtual counterpart of the toy on the server, using the registration code (1025).

FIG. 10C is an illustrative flowchart depicting an example embodiment of a method of registering and sharing toys and apparel and creating links in an online social network, and designing and manufacturing toys. The method 1031 can include providing a fastener for attaching a toy to an article of apparel (1032). The method 1031 can include using a design tool on a server to modify the design of a toy to create a new custom design (1033). The method 1031 can include using a production process to create a new toy based on the custom design (1034).

Embodiments of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices).

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

While this specification contains many specific implementation details, these should not be construed as limitations on the scope of any inventions or of what may be claimed, but rather as descriptions of features specific to particular implementations of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of relating a first user with a second user in an online social network via a server, comprising:
accessing, by the server, a first data structure storing a first user account associated with the first user in the social network, the first user account associated with a first identifier of a first scanning device;
accessing, by the server, a second data structure storing a second user account associated with the second user in the social network, the second user account associated with a second identifier of a second scanning device;
modifying, by the server, responsive to receiving a first registration code of a first physical toy via the first scanning device, the first user account to include the first registration code of the first physical toy;
modifying, by the server, responsive to receiving a second registration code of a second physical toy via the second scanning device, the second user account to include the second registration code of the second physical toy;
receiving, by the server via the first scanning device, the second registration code of the second physical toy;
receiving, by the server via the second scanning device, the first registration code of the first physical toy;
comparing, by the server, responsive to receiving the second registration code via the first scanning device and the first registration code via the second scanning device, the first user account with the second user account;
identifying, by the server, based on the comparison, a transaction between the first user account and the second user account, the transaction including the first physical toy and the second physical toy; and
generating, by the server, a link in the social network between the first user account and the second user account based on the identification of the transaction between the first user account and the second user account.

2. The method of claim 1, further comprising:
identifying, by the server, based on the first registration code, a first characteristic of the first physical toy;
identifying, by the server, based on the second registration code, a second characteristic of the second physical toy;
comparing, by the server, the first characteristic of the first physical toy and the second characteristic of the second physical toy; and
weighting, by the server, based on the comparison of the first characteristic and the second characteristic, the link in the social network between the first user account and the second user account.

3. The method of claim 1, further comprising:
associating, by the server via the first data structure, a first virtual toy with the first registration code of the first physical toy; and
associating, by the server via the second data structure, a second virtual toy with the second registration code of the second physical toy.

4. The method of claim 3, further comprising:
modifying, by the server responsive to input from the first user, via the first data structure, the first virtual toy; and
manufacturing, by a production module, based on the modification, a third physical toy.

5. The method of claim 1, further comprising:
associating, by the server via the first data structure, a first location identifier of a first location device with the first user account;
associating, by the server via the second data structure, a second location identifier of a second location device with the second user account;
receiving, by the server via the first location device, a first location of the first physical toy;
receiving, by the server via the second location device, a second location of the second physical toy;
modifying, by the server, responsive to receiving the first location, the first data structure to include the first location of the first physical toy; and
modifying, by the server, responsive to receiving the second location, the second data structure to include the second location of the second physical toy.

6. The method of claim 5, further comprising:
comparing, by the server, the first location of the first physical toy and the second location of the second physical toy; and
weighting, by the server, based on the comparison of the first location and the second location, the link in the social network between the first user account and the second user account.

7. The method of claim 1, further comprising:
associating, by the server via the first data structure, a box identifier of a storage box with the first user account;
receiving, by the server via the storage box, a utilization statistic of the first physical toy; and
modifying, by the server, responsive to receiving the utilization statistic, the first data structure to include the utilization statistic of the first physical toy.

8. The method of claim 7, further comprising:
weighting, by the server, based on the utilization statistic, the link in the social network between the first user account and the second user account.

9. The method of claim 1, further comprising:
modifying, by the server, responsive to receiving a first apparel registration code of a first article of apparel via the first scanning device, the first user account to include the first apparel
registration code of the first article of apparel; and
modifying, by the server, responsive to receiving a second apparel registration code of a second article of apparel via the second scanning device, the second user account to include the second apparel registration code of the second article of apparel.

10. The method of claim 9, further comprising:
comparing, by the server, the first apparel registration code of the first article of apparel and the second apparel registration code of the second article of apparel; and
weighting, by the server, based on the comparison, the link in the social network between the first user account and the second user account.

11. The method of claim 9, further comprising:
comparing, by the server, the first apparel registration code of the first article of apparel and the first registration code of the first physical toy;
generating, by the server, based on the comparison, a recommendation for a purchase of a third physical toy; and
displaying, by the server responsive to input from the first user, the recommendation.

12. The method of claim 9, further comprising:
associating, by the server via the first data structure, a first virtual article of apparel with the first apparel registration code of the first article of apparel.

13. The method of claim 14, further comprising:
modifying, by the server responsive to input from the first user, via the first data structure, the first virtual article of apparel; and
initiating manufacturing, by a production module, based on the modification, a third article of apparel.

14. A system for relating a first user with a second user in an online social network, comprising:
a server including a processor and memory configured to:
access a first data structure storing a first user account associated with the first user in the social network, the first user account associated with a first identifier of a first scanning device;
access a second data structure storing a second user account associated with the second user in the social network, the second user account associated with a second identifier of a second scanning device;
modify, responsive to receiving a first registration code of a first physical toy via the first scanning device, the first user account to include the first registration code of the first physical toy;
modify, responsive to receiving a second registration code of a second physical toy via the second scanning device, the second user account to include the second registration code of the second physical toy;
receive, via the first scanning device, the second registration code of the second physical toy;
receive, via the second scanning device, the first registration code of the first physical toy;
compare, responsive to receiving the second registration code via the first scanning device and the first registration code via the second scanning device, the first user account with the second user account;
identify, based on the comparison, a transaction between the first user account and the second user account, the transaction including the first physical toy and the second physical toy; and
generate a link in the social network between the first user account and the second user account based on the identification of the transaction between the first user account and the second user account.

15. The system of claim 13, wherein the server is further configured to:
identify, based on the first registration code, a first characteristic of the first physical toy;
identify, based on the second registration code, a second characteristic of the second physical toy;
compare the first characteristic of the first physical toy and the second characteristic of the second physical toy; and
weight, based on the comparison of the first characteristic and the second characteristic, the link in the social network between the first user account and the second user account.

16. The system of claim 13, wherein the server is further configured to:
associate, via the first data structure, a first virtual toy with the first registration code of the first physical toy; and
associate, via the second data structure, a second virtual toy with the second registration code of the second physical toy.

17. The system of claim 16, wherein the server further comprises a production module and is further configured to:
modify, responsive to input from the first user, via the first data structure, the first virtual toy; and
initiate manufacturing of a third physical toy based on the modification.

18. The system of claim 13, wherein the server is further configured to:
associate, via the first data structure, a first location identifier of a first location device with the first user account;
associate, via the second data structure, a second location identifier of a second location device with the second user account;
receive, via the first location device, a first location of the first physical toy;
receive, via the second location device, a second location of the second physical toy;
modify, responsive to receiving the first location, the first data structure to include the first location of the first physical toy; and
modify, responsive to receiving the second location, the second data structure to include the second location of the second physical toy.

19. The system of claim 18, wherein the server is further configured to:
compare the first location of the first physical toy and the second location of the second physical toy; and
weight, based on the comparison of the first location and the second location, the link in the social network between the first user account and the second user account.

20. The system of claim 13, wherein the server is further configured to:
associate, via the data structure, a box identifier of a storage box with the first user account;
receive, via the storage box, a utilization statistic of the first physical toy;
modify, responsive to receiving the utilization statistic, the first data structure to include the utilization statistic of the first physical toy.

21. The system of claim 20, wherein the server is further configured to:
weight, based on the utilization statistic, the link in the social network between the first user account and the second user account.

22. The system of claim 13, wherein the server is further configured to:
modify, responsive to receiving a first apparel registration code of a first article of apparel via the first scanning device, the first user account to include the first apparel registration
code of the first article of apparel; and
modify, responsive to receiving a second apparel registration code of a second article of apparel via the second scanning device, the second user account to include the second apparel registration code of the second article of apparel.

23. The system of claim 22, wherein the server is further configured to:
compare the first apparel registration code of the first article of apparel and the second apparel registration code of the second article of apparel; and
weight, based on the comparison, the link in the social network between the first user account and the second user account.

24. The system of claim 22, wherein the server is further configured to:
compare the first apparel registration code of the first article of apparel and the first registration code of the first physical toy;
generate, based on the comparison, a recommendation for a purchase of a third physical toy; and
display, responsive to input from the first user, the recommendation.

25. The system of claim 22, wherein the server is further configured to:
associate, via the first data structure, a first virtual article of apparel with the first apparel registration code of the first article of apparel.

26. The system of claim 25, wherein the server further comprises a production module and is further configured to:
modify, responsive to input from the first user, via the first data structure, the first virtual article of apparel; and
initiate manufacturing of a third article of apparel based on the modification.
